(19) United States
(12) Patent Application Publication
(10) Pub. No.: US 2019/0131020 A1
(43) Pub. Date: May 2, 2019

(54) Room temperature alternative superconductor, beta nuclear reactor and more

(71) Applicant: Yanming Wei, Mountain (CA)

(72) Inventor: Yanming Wei, Mountain (CA)

(21) Appl. No.: 15/486,412

(22) Filed: Apr. 13, 2017

(51) Int. Cl. G21C 1/02

(52) U.S. Cl. CPC G21C 1/02

(57) ABSTRACT

Combining alternative room temperature superconductor and neutrinos lens with other special means can enormously accelerate beta decay, so as to directly generate electricity or thermal energy. Not by extreme low temperature for superconductor, as alternative, mechanically spinning electric charged regular conductor can mimic superconductor in normal ambient condition, but with convenience and far lower energy consumption than cryogenic deep freezer. The virtual-current-generated strong magnetic field is one of the crucial factors to speed up beta decay, as well as the synergy catalysis of focused neutrinos. In a sense, it is a controlled yet accelerated decay nuclear reactor.

As subject inventions all are so cutting edge, that none could be understood without warm up the up-to-date science principles, discoveries of mine & others, theory analysis, experiments verification, even new physics hypothesis.

Supposedly science discoveries and suppositions should be firstly published in peer-reviewed journals, however I cannot wait for that long time of propagating new knowledge originated from my researches, and it matters more for me to apply those in technology innovations and fresh inventions that can fix some real world problems, especially bring out the best solutions for human beings imminent energy crisis.

§ 1. How Fast do Electrons Flow when a Conductor Wire is Carrying Current?

Let me take copper wire as example, and assuming current I=1 A, diameter 2 mm.

Electricity is most commonly conducted in copper wires. Copper has a density of 8.94 g/cm³, and an atomic weight of 63.546 g/mol, so there is 140685.5 mol/m³. In one mole of any element there are 6.02*10²³ atoms (Avogadro's constant). Therefore in 1 m³ of copper there are about 8.5*10²⁸ atoms (6.02×10²³*140685.5 mol/m3). Copper has one movable electron per atom as its outer shell configuration is 4s(1)3d(2+2+2+2+2), hence the charge density n is equal to 8.5×10²⁸ electrons per cubic meter.

As per the assumption, such wire has a cross sectional area of 3.14×10⁻⁶ m² (A=π*(0.001 m)²). The charge of one electron is q=−1.6×10⁻¹⁹ C, with all given data, electrons drift velocity is:

$$u = \frac{I}{nAq} = \frac{1 C \text{/} s}{( 8.5 * {10}^{28} {m}^{- 3} ) * ( 3.14 * {10}^{- 6} {m}^{2} ) * ( 1.6 * {10}^{- 19} C )}$$

$$u = 2.3 * {10}^{- 5} m \text{/} s = 23 μ m \text{/} s$$

It obviously indicates the electrons drift very slowly.

Strictly speaking, there are no free electrons in conductor; all electrons are bounded, except the unpaired electrons are shared by crystal lattice of 1 or multiple atoms. In a sense, the so-called free electrons are moving in parallel $-shape routines, never straight lines. It is the said routines along that joule heat is generated when the movable electrons are switching smoothly from one lattice unit to next lengthwise, and it is also referred as resistance phenomenon.

When every 2 moveable electrons are all incorporated as Cooper pair, the superconductor phenomenon will occur, which means resistance is zero. Current technology can only realize it in extreme cold cryogenic environment from temperature 1K to 100K roughly.

It will cost quite large amount of energy to maintain cryogenic environment, though the electric current itself does not consume energy because of zero resistance.

### § 2. Alternative or Quasi Superconductor

As per previous calculation, now we know the electron's drift velocity is very slow, but by mechanic means, electric charges can be easily speeded to very high velocity, e.g. sonic speed, that is many orders of magnitude greater than the snaillike electrons in conductors.

In the late sections, I will propose an invention where the charged disks rotate up to million rpm (rotation per minute). The key problems are how to carry charges as more as possible on disks, and lessen the energy of maintenance of high speed spin as low as possible.

Even when disks rotating, its surface charges are still stationary in reference frame of disks, but charges do rotate fast if seen from reference frame of ground, hence, there is virtual electric current though no real current. Just like as real current, huge virtual current can also induce strong magnetic field, but without joule heat, hence I name it alternative superconductor.

In a sense, perhaps our Earth is also alternative superconductor because she has a net negative charge of about 400,000 Coulombs and spin in period of 24 hours.

It is the virtual current that induces Earth magnetic field recorded 0.25-0.65 Gauss, roughly coincident with theoretical B=μnI (n=1, I=virtual current) on approximation of solenoid.

The net charge of Earth can be deduced from formula of surface electric field strength:

$$E ( r ) = \frac{Q}{4 {πϵ}_{0} {r}^{2}} \approx 100 V \text{/} m ( recorded mean volts per meter )$$

One day in future, with the cosmic rays sending more and more protons to Earth, polarity of net charge will toggle to positive, then our Earth magnetic poles will switch reversely. Hence never assume the cosmic rays dose, components and energy spectra are constant.

The main purpose of quasi-superconductor in my inventions is for making strong magnetic field, and together with strong electric field and neutrino focusing, beta decay of special selected elements can be speeded, so as to use it as commercial nuclear energy source without the potential high risk of ecology disaster of the usual uranium-235 fission system.

### § 3. How to Get High Density of Charges on Disks?

Answering this question is just one of my inventions.

In my previous patent application: “Dielectric blade comb piston unlimited voltage generator, fusor and more” (ref. 1), a new theory dielectrodynamics has been proposed, where only the sandwiched dielectric media is switchable.

By extending the theory of dielectrodynamics, herein, only electrode plates can be rotatable.

In my alt-superconductor system, the larger the density of charges, the higher the virtual current, and then the stronger the generated magnetic field will be.

But there is limitation on σₘₐₓ the max density of charges, because σₘₐₓ=∈*Eₘₐₓ where ∈ is permittivity of dielectric medium and Eₘₐₓ is the max tolerable electric field strength or breakdown threshold.

Even if no limit on Eₘₐₓ, σₘₐₓ is still limited by the atom lattice density. Empirically speaking, the acceptable and feasible densest charges should ensure that there are about 10 neutral atoms between 2 charged atoms either positive or negative, otherwise it becomes plasma.

For example of copper Cu electrode plate, atomic radius is 145 pm, 10 atoms span 1450 pm or 1.45 nm, assuming partial atoms positive charged with 1 electron loss, therefore empirical max density of charges is about 1.6*10⁻¹⁹/(1.45*10⁻⁹)²=0.076 coulomb per square meter.

### § 4. Why the Outer Core of Earth is Liquid?

The outer core counts from radius 1210 km to 3510 km, and total thickness is about 2300 km.

Modern seismic measurements have confirmed that the outer core of Earth is in liquid state.

Of course, the simplest answer is that: too hot can make anything liquid. But how and where does the heating energy come from?

Our textbooks are giving the wrong answer or alternative facts.

My new research result shows the answer should have relation with the mystery neutrinos, especially the very low energy neutrinos.

Don't forget the Sun is producing tremendous neutrinos after wake of fusion reaction. The great nature sets a mechanism to dissipate about 40% energy for beta decay. Although most solar energy is from fusion reaction, there is still significant energy from β+ decays that radiate neutrinos and take away about 3% of total energy.

The recorded solar energy mean density on ground is about 1000 W/m², thus the max energy density before deduction of atmosphere absorption could be 1500 W/m², hence the estimation of neutrinos flux energy density on ground is circa 3%*1500=45 W/m².

The neutrino energy spectrum is in continuum distribution ranging from zero eV to the theoretical energy of beta decay.

Current neutrino detection experiments can see 1.8 MeV above neutrinos that are from decay of 7Be or 8B, yet minority in contrast to the 99.6% mainstream pp reactions that emit neutrinos in circa 210 keV level.

Scientists are still working hard on detection of the pp low energy neutrinos by tremendous volume of isotopes 71Ga or 37Cl.

According to my research, low energy neutrino has relative higher cross section, despite the known cross section of 1.8 MeV is very tiny 10⁻⁴² cm²=10⁻¹² μb (micro barns) that means: even travelling light-year level thick lead wall, the loss of neutrinos may be still insignificant.

Generally speaking, the lower the reaction energy, the higher the cross energy, for example, usual chemical reaction with energy transaction from a few eVs to 2 digital eVs, hence their cross section can easily reach millions barns, in contrast, the 235U fission cross section 584 barns for thermal neutron, and the famous fusion D+T=He+n only 5 barns.

As per above trend, the low energy neutrinos with mili-eV up to 100 keV will possess higher cross section and refraction effect with refractive index >2.0.

For regular glass ball, the caustic is outside of ball as its refractive index n<2.0, but otherwise, the incident parallel light rays will form small caustic area inside the ball, and so does the situation for the Earth and invisible neutrinos.

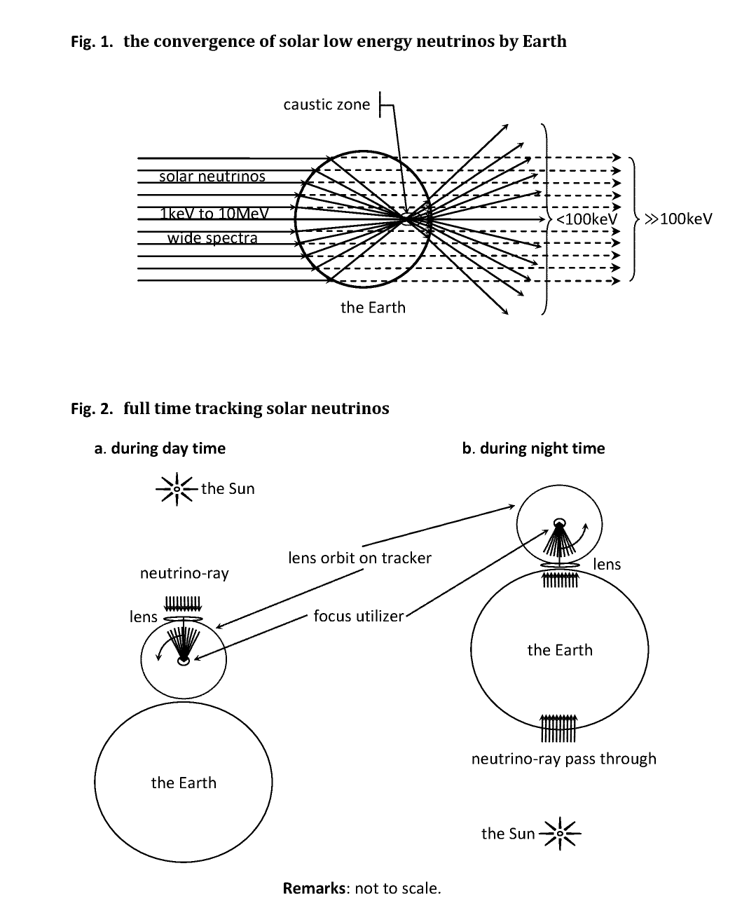

FIG. 1 illustrates the convergence of low energy solar neutrinos inside the Earth, and the energy density in the caustic area is yet quite high though not focused to one point. Obviously, only a narrow bandwidth at low energy end of solar broad spectrum can render high refractive index, most 100+ keV (may up to 10 MeV) high energy neutrinos just straightly pass through the Earth with rarest or without interaction.

The major components of Earth outer core are iron and nickel.

Fortunately one of Fe (Iron) isotopes has very lower nuclear energy level: it is the 57Fe which first energy level is only 14 keV and its sibling abundance is 2.1%.

The term sibling abundance stands for molecular proportion of one isotope among all sibling isotopes of same element family, e.g. iron's all natural isotopes: 54Fe, 56Fe, 57Fe, 58Fe.

As the nuclear spin change ΔJ of transition between ground state (shorted as GS later, Jπ=1/2−) and first energy level (Jπ=3/2−) is appreciable ΔJ=1, according to selection rules, its allowance degree is still good though not the best case (ΔJ=0), and a short half life time 98.3 ns of gamma decay does exist as an isomer's feature.

If some neutral current can excite 57Fe to the first energy level, then the delayed de-excitation gamma decay can release the energy that was harvested from the pass-through neutral current. Neutrinos neutral current possess such potentiality, but normal neutrinos flux is uneasy to interact with matters unless the flux can be converged or focused so as to increase energy density greatly.

Luckily, our Earth is a good lens for low energy neutrinos and the Sun is a good source of low energy neutrinos.

For neutral current of low energy neutrinos, if its energy >14 keV, then within the neutrinos caustic zone, i.e. the iron outer core of Earth, yet still inside Earth, there is high possibility of 57Fe excitation activity, and the leaving neutrinos carry away the remnant energy after a small deduction of 14 keV.

As neutrinos are fermions, when focusing or compressing, Pauli exclusive principle will regulate the “thick” incompressible fermions flux to form “thin” compressible Bosons stream so as to compact particles as small volume as possible until down to a point by yielding to converging pinch, in straight words, 2 or more even number neutrinos tend to combine as a quasi-particle with integer spin quanta, e.g. 1 (2 neutrinos), 2 (4 neutrinos), 3 (6 neutrinos), etc.

Super high spin boson quasi-particle is always hard to form, but spin under 10, especially 1 spin Boson is relatively easy.

To excite nuclear for different energy levels, the neutral current should be Bosons current, because the required spin change ΔJ is always integer. For example, photons neutral current is just Bosons current, so, it can be used to excite nuclear.

For 2-neutrino quasi-particle, even each neutrino only carries 7 keV, the quasi-particle Boson can still satisfy the threshold energy 14 keV of 57Fe first energy level.

As the outer core is so thick 2300 km, the caustic zone of 14 keV neutrinos alone cannot cover such a long distance, but most likely a small zone nearby the end of inner core.

As to how the far end (nearby the stiffer mantle of Earth) being heated, it must be credited to the neutrinos energy absorption of another major element nickel. Luckily the isotope 61Ni also has a very low energy level 67 keV, Jπ=5/2−, T_{1/2}=5.34 ns, and gamma decay to GS Jπ=3/2− needs ΔJ=1.

The abundance of 61Ni is 1.14%, though less than 57Fe 2.1%, however, the delayed gamma photon 67 keV is about 4.8 times hotter than the 14 keV of 57Fe.

In my neutrino optics, the higher the energy of neutrinos, the lower the refractive index, thus the closer to center of Earth, the lower the energy of neutrinos thereby, vice versa, just like as a prism separating natural rays to a spectrum from red to violet, and nomenclature defines it as chromatic aberration.

Last a few words:

There is a special thin shallow layer under our feet 80 km: asthenophere with rough thickness 120 km, this crust is also very hot and elastic or quasi-liquidic, and that is why geology proposes tectonic plate drift theory.

In this crust, the main elements are diversified, such as Fe, Mg, K, P, S, Mn, Zr, V, and U.

The heating energy is mainly from the focused neutrinos charged current accelerating the energy-possible-but-spin-locked beta or double beta decay, such as 40K, 50V, 96Zr, and the decay long chain of uranium. The generated energy is far greater than aforementioned low energy absorption of 14 keV by 57Fe and 67 keV by 61Ni from passby converging neutrinos.

However there still could be elements that produce energy by low energy neutrinos neutral current interaction in the same way as outer core, such as 55Mn, the only stable isotope of Mn, 125 keV Jπ=7/2− with GS Jπ=5/2−.

§ 5. Why do Neutral Particle Rays Tend to Refract when Crossing 2-Medium Interface?

We often take the refraction phenomenon as granted. But let me show a rare situation: is a single photon will refract?

In orthodox geometry optics, refraction of light rays will always happen, but in quantum optics, it is not 100% guaranteed unless there are enough photons in a ray so as to appear some coherent degree more or less.

Hence, one single photon, even in visible waveband, it will never refract when passing through whatever interface of transparent media. It is well known that single photon is hard to separate, but even for an imagined dotted “light ray” with countable separated photons, if the interval space between every 2 neighbor photons is too long, then such a weak ray also does not refract, because photons coherent degree is zero.

Fortunately in our colorful world, this situation hardly occurs, hence refraction phenomena can always be observed anywhere, because either artificial light source or solar light always provide enough photons.

For neutrinos flux, above rule is still valid.

Because of coherent interference, neutrinos propagating in matter have an index of refraction n, its value can be determined by formula (ref. 2):

$$n = 1 + \frac{2 π}{{k}^{2}} Nf ( 0 )$$

Here k is the neutrinos average momentum, N is the quantum density of number of scatters per unit volume and f(0) is the forward scattering amplitude.

This is a well-known result, largely due to a pioneering work of Wolfenstein and the discovery of resonance effects of Mikheyev and Smirnov.

Hence, the lower the neutrino energy, and the higher the quantum density (good coherence), then, the higher the refractive index will be, even larger than 2.0 possible.

Conclusively, refraction is driven by so-called “coherent force”!

Of course, gravitation force can also refract neutrinos, but the effect is extremely weak, e.g. the neutrinos from galactic core will be focused by the solar gravitation to 24 astronomical units, i.e. the distance between the Uranus and Neptune orbit radii, as per the authoritative research report. See ref. 3 for details.

### § 6. Neutrino's Matter Wave Length and Flux

Most researchers claim that electron-flavor neutrino' rest mass m₀ is less than 0.12 eV, some literatures even present the accuracy value: 2.1*10⁻⁴ eV (ref. 4), and the well accepted speed is just same with photon.

Hence, the matter wave length, aka DeBroglie wave length:

$$λ = \frac{ℏ}{p} ,$$

where p is the momentum, ℏ is the reduced plank constant. With relativistic consideration,

$$λ = \frac{ℏ c}{\sqrt{\overline{{E}^{2} + 2 {Em}_{0} {c}^{2}}}} ,$$

E is the kinetic energy, c is light speed.

Let's do some test calculation: for E=1 MeV neutrino, λ=0.2 pm; for 100 keV, λ=2 pm; for 10 keV, λ=20 pm; for very small energy 2.2 eV, λ=0.1 μm (violet); and for 20° C. thermal neutrino (25 meV), λ=8 μm (infrared).

Interestingly the matter wavelength λ of thermal neutrinos does fall in infrared waveband that is regarded as comfortable thermal source, just a coincidence or does it imply that atmosphere temperature is gauged or determined by ghost-like neutrinos?

By the way, don't be confused with the thermal neutron's matter wavelength 1.8 Å that is too hot, many orders of magnitude higher than 20° C., if it is electromagnetic wave, i.e. photon.

Given 45 W/m² power density and mean energy 210 keV, solar neutrinos flux can be estimated: 1.4*10¹⁵ m⁻²s⁻¹ or 1.4*10 cm⁻²s⁻¹. Superposing the huge cosmic background relic neutrinos, total low energy neutrino flux will be increased by another many orders of magnitude.

There is countless great number of neutrinos sources out of solar system, especially, in all supernovas, unlike the humble 3% quota in solar, 99% of radiation is carried away by neutrinos. But the extreme remote distance from a few to billions light-years will undoubtedly attenuate energy of neutrinos and the flux will be diluted when neutrinos reach our Earth. Hence, until now, there is no convincible data regarding non-solar neutrinos flux and energy spectrum.

### § 7. Any Substantial Proof of Neutrino Flux Refraction?

In fact, mainstream science community has already indirectly proved that neutrons flux passing through our Earth does be refracted.

The literature “First Indication of Terrestrial Matter Effects on Solar Neutrino Oscillation” (ref. 5) claims that: the neutrinos flux in night is 3.2% more than in day.

Unfortunately the experiment team explained that such phenomenon is caused by 3-favor oscillation during the long distance travel from Sun to Earth.

As the Sun-Earth distance is changing day by day continuously, e.g. January 4 is the closest day, July 4 is the farthermost day that is 4.9 million km farther than the closest distance, and neutrino' 3 favors are supposed to oscillate in some distance period, hence if the team's explanation is true, then the recorded night minus day events during 1 year length should oscillate between top and bottom lines, but their experiments always indicate night events 3.2% more than day's.

Based on above analysis, I believe it is caused by the Earth refraction effect on neutrinos flux, because Earth's lensing effect can converge neutrinos in night then increase the flux density.

Because the team detects boron isotope 8B electron neutrino, its energy is about single digital MeV level, hence the refractive index must be lesser than those of low energy neutrinos with 2 or 3 digitals keV level, therefore the refractive index is probably a little bit higher than 1, thus, the caustic zone is outside of Earth and far away over the deep night sky, no wonder 3.2% more events in night can be recorded.

It can be deduced that solar pp reaction low energy neutrinos can be refracted more degree than the 8B neutrinos, hence the caustic zone is more close to ground, then more night events far above 3.2% increment can be logged, if instrument sensitive to this neutrinos.

For the very low energy neutrinos, because caustic zone is deeply inside Earth, hence in night, the out flux on ground is divergent, and even though, the flux density may be still higher than unfocused parallel flux.

### § 8. Why is the Replicability of all Prior LENRs so Low and Unstable?

LENR stands for Low Energy Nuclear Reactor.

Since Pons and Fleischmann reported their findings that Pd-D electrolysis experiments generate nuclear-reaction-level anomalous energy in 1989, many researchers and organizations all over the world have input their efforts in phenomena explanation, replicability experiments and more deeper research.

However, the results are not always optimistic: either low replicability or instability.

In 2006, a Chinese team delivered a paper: “Changes of decay rates of radioactive 111In and 32P induced by mechanic motion” (ref. 6), they claimed fast rotation can affect beta decay rate.

Dramatically, only 2 year later, another team delivered a challenging paper: “Can the decay rate of 32P be changed by mechanic motion?” (ref. 7), they refuted the claims in reference 6.

In 2011, a famous Russian experimental physicist Parkhomov delivered a paper: “Deviations from Beta Radioactivity Exponential Drop” (ref. 8).

He claimed that cobalt 60Co radioactive source will demonstrate unusual beta decay drastically quickened by almost 700 folds if it is placed at the focus of a celestial sphere scanning mirror-type astronomical telescope and a star is just being scanned.

He explained that this phenomenon may be caused by focusing energy-attenuated cosmic neutrinos flux or even big bang relic neutrinos flux.

Luckily the replicability of his experiment is very good, until now, nobody challenges his claims.

In 2014, a New Zealand team delivered a summary paper: “Hidden Variable Theory Supports Variability in Decay Rates of Nuclides” (ref. 9).

On my experience, I believe that: the main causation of low replicability is that all repeaters ignored the importance of solar neutrino flux realtime direction, and they probably copycatted in wrong time so as unconsciously to result in mismatch between neutrinos flux incoming direction and orientation of experiment devices.

Usually, the original experimenters used to introduce detail configuration and procedure in published paper, but never to state what time they conducted.

For example, if original experimenters got the positive effect at noon 12:00, and the followers in same district retry at morning 8:00, then probably a negative effect will be recorded, because neutrinos flux pour down vertically at noon, but horizontal at morning, circa 90° difference.

The location is also important factor, simply thinking, solar neutrinos flux direction is not same in north hemisphere with south hemisphere even at same local time.

Frankly speaking, the originators do not intend to hide the time when they got the plausible effect, probably themselves just luckily hit the right time without aware of relation to neutrinos.

The beta decay acceleration by high speed mechanic spin is very typical example. If the rotating disk faces up to sky, the best effect will occur at noon, but if retry at sunset time, you absolutely cannot get the same result with the originators, then probably jeer the originators crackpot.

### § 9. Any Substantial Proof of Neutrino Flux Reflection?

In fact, aforementioned Parkhomov's experiment is just the substantial proof of neutrinos flux reflection, because the parabolic mirror-type astronomical telescope does focus neutrinos in his experiment. Now let me present further and deeper scientific explanations.

To superficially accept his explanation is not enough, as it is a little bit conservative and he also did not present any explicit useful lemma.

For convincibilty and exploring implicit lemmas, 60Co and its decay product 60Ni should be analyzed in detail about nuclear energy levels and possible channels of decay transmutation.

To my best understanding, his experiment is the best convincible one that proves 5 facts or lemma:
i. Good use of neutrinos can greatly accelerate beta decay;
ii. Low energy neutrinos can reflect on mirror;
iii. Boson quasi-particle comprising neutrinos in even number can be formed under focusing condition;
iv. Such a quasi-particle in high spin can excite nucleus to overcome high spin lock;
v. Only β− decay can be catalyzed by neutrinos, as well as only β+ or electric capture decay can be catalyzed by antineutrinos; converse decay will be slowed down.

According to NNDC (National Nuclear Data Center) experiment-based open official data, 60Co decay energy Q(β−)=2822 keV, T_{1/2}=1925 days.

Further let me analyze respective energy levels and possible decay routes. As lots of energy levels, here only list the lowest a few important levels.

Nucleus 60Co: GS˜Jπ=5+; 1^{st} level isomer state! E₁=58 keV, Jπ=2+, T_{1/2}=10.4 minutes with 2 possibilities: internal conversion (IT) in 99.75% chance & β− in 0.25% chance; 2^{nd} level˜E₂=277 keV, Jπ=4+, T_{1/2}≈0, very fast gamma decay to GS.

Nucleus 60Ni: GS˜Jπ=0+; 1^{st} level˜E₁=1332 keV, Jπ=2+, T_{1/2}=0.7 ps, gamma decay to ground GS; 2^{nd} level˜E₂=2158 keV, Jπ=2+, T_{1/2}=0.6 ps, gamma decay with 2 routes to GS; 3^{rd} level˜E₃=2284 keV, Jπ=0+, T_{1/2}>1.5 ps, gamma decay with 2 routes to GS; 4^{th} level˜E₄=2505 keV, Jπ=4+, T_{1/2}=3.3 ps, gamma decay with 3 routes to GS.

Obviously the decay transmutation from 60Co GS to 60Ni GS is spin-locked, because ΔJ=5 is too high! Normally, the most possible transmutation routes should be 60Co GS to 60Ni 4^{th} (ΔJ=1), 3^{rd} (J=3) and 2^{nd} (ΔJ=3) energy level.

As Dr. Parkhomov claims almost 700 times faster than normal decay speed, hence the start point is probably not from 60Co ground state, but from excited state: the 1^{st} energy level E₁=58 keV, Jπ=2+, T_{1/2}=10.4 minutes, i.e. an isomer state!

Theoretically, via the isomer decay route, the β− decay will be accelerated to (1925*24*60/10.4)*0.25%=666 times. What a magic signature, the experiment data greatly coincides with the calculation!

So it seems that low energy (<100 keV) neutrinos can be either refracted or reflected, just like as the properties of normal visible light interacting with lens or mirror.

More excitant finding: the focused low energy neutrino flux not only can transfer energy to 60Co, but also even can easily modify spin 3 quanta, because excitation from ground state to 1^{st} energy level need spin change ΔJ=5−2=3.

As single neutrino is Fermion, it can only modify ½ spin quantum, so, modifying 3 quanta needs a Boson quasi-particle comprising at least 6 neutrinos in even number.

For Fermions to form Bosons, there must be a compressing environment so as to induce Pauli exclusive force. Optics focusing can do it.

The threshold energy to excite nuclei will be decreased by many folds if considering multiple neutrinos bounded quasi-particle Boson, e.g. for 6-neutrino bounded Boson, every neutrino only need E₁/6=9.7 keV to excite 60Co to 58 keV; for 6000-neutrino bounded Boson, every neutrino only need 9.7 eV.

In parabolic mirror, as per geometry optics, theoretically all energy scale neutrinos can focus in same point without chromatic aberration.

Hence, it is hard to estimate the neutrinos energy spectrum at the focus point, because not to mention 58 keV even 300 keV or so neutrinos are still regarded as “Dark Matter” until today.

But one rule is probably true: the lower energy the neutrinos, the higher probability to be reflected on mirror.

By the way, I am aware that some researchers believe the existence of magnetic monopole and suggest it is the high spin excited state of neutrino. Yes, unleashing the spin-locked isomer or yrast nuclear energy DOES need high spin projectiles, perhaps my modeled multiple even number neutrinos bounded quasi-particle Boson is just the imagined magnetic monopole.

### § 10. What Materials are Good for Neutrinos Lens?

In conventional optics, lenses are made of glasses, but in neutrinos optics, heavy metals are preferred, because higher density of electrons is good for scattering neutrinos, hence, lead, mercury and other heavy metals are good choices, though not transparent like as glasses.

For photons passing through media interface, the electromagnetic wave of photons will affect the polarization of dielectric material, then photons group velocity will be slowed down, that is how its permittivity determines the value of photons refractive index.

Similarly, for neutrinos passing through medium, the neutral current will transfer energy to electrons or nuclei, then neutrinos group velocity will be slowed down, hence the energy level of electron or nucleus determines the value of neutrinos refractive index.

As the interaction between neutrinos and matters are so tiny, most high energy (roughly >>100 keV, e.g. 10 MeV) neutrinos just simply pass through any medium without refraction or with the refractive index of extreme close to 1; only low energy neutrinos can exhibit phenomenal refraction, even with refractive index larger than 2.0.

If a metal has very low energy first level of excited nuclear state, then it will exhibit larger refractive index to low energy neutrinos rays.

Mercury 201Hg is the most outstanding isotope because its first energy level of nucleus is merely 1.6 keV, only second lowest to the 77 eV of uranium 235U, and more importantly, it is liquid metal, so it is possible to dynamically adjust focus of mercury lens for low energy neutrinos by arbitrary change of lens surface curves. Such a lens is also called adaptive lens.

The sibling abundance of 201Hg is 13%, combined with its heat perturbation of 1.6 keV nuclear energy level damping ambient neutrinos energy then gamma decaying, and its electron-shell inert 6 s² relativistically affected orbital electron pair, perhaps, that is why mercury is in liquid state, because the environment exists rich commensurate low energy neutrinos in all directions, and harvesting the energy of low energy neutrinos can make mercury very sensible to temperature, so result in high thermal expansion.

It is difficult to detect the internal 1.6 keV photons in bulk mercury, because it can be easily absorbed by low orbital electrons then converted to thermal energy, even temporarily not absorbed, its refractive index (>2.0) will enable its ray to undergo internal full reflection easily.

Although lens quality matters, tracking solar neutrinos is also important, and different from tracking solar light that can only make sense when sunshine is permitted by good climate, instead of part time light tracking, full time 7×24 neutrinos tracking can harvest almost equal radiations, no matter day or night, and climate good or bad.

FIG. 2 illustrates abstract solar neutrinos tracking system. Therefrom, if lens is over the focus utilizer during day time, as showed in its sub-FIG. 2a, i.e. focus utilizer is between lens and ground, then after sunset, the lens should be turned to underside of focus utilizer, i.e. lens is between focus utilizer and ground, as showed in sub-FIG. 2b where the solar neutrinos first pass through the sunrisen zone then pass out sunset zone of Earth before entering the focus utilizer. What a total upside down!

Obviously, if the neutrinos lens is not movable, then it cannot focus extreme low energy neutrinos at night, unless let the focus utilizer move to new position above lens after sunset.

### § 11. How Powerful can the Beta Decay Nuclear Fuel Be?

In a sense, all β+ and β− decay nuclides are “burning” naturally in slow or fast rate. The important parameter half life means how long time span from the nuclide's fresh existence to the moment burnt 50%.

People prefer to use energy density such as watts per kg mass when comparing or judging how powerful, let me deduce universal formula in convenience for all interested readers.

Definition of variables or parameters (if not dimensionless, unit in brackets):

W=energy density (watt/kg); λ=atom mass; B=abundance of designated isotope, for mono-isotope element or full-enriched element, B=100%; Q=decay energy (eV); T_{1/2}=half life (s).

For 1 kg natural element, the total number of atoms is approximate to 1/(A*amu), and the number of one designated isotope atom is B/(A*amu), here amu is atom mass unit that is precisely 1/12 of carbon-12 atom, i.e. 1 amu=1.67377*10⁻²⁷ kg.

By the decay exponential law,

$$N ( t ) = {N}_{0} * {e}^{- \frac{ln 2}{{T}_{1 \text{/} 2}} t} ,$$

where N(t) is the remnant undecayed number of nuclei at time t, N₀ is the initial number of nuclei. To calculate power, the differential of N(t) is first deduced as:

$$Δ N \text{/} Δ t = - {N}_{0} * ln 2 \text{/} {T}_{1 \text{/} 2} * {e}^{- \frac{ln 2}{{T}_{1 \text{/} 2}} t}$$

Normalizing N₀ to the number of decaying isotope atoms in 1 kg natural element atoms: B/(A*amu), and considering short time trend: t is far less than T_{1/2}, or t/T_{1/2}≈0, then:

ΔN/Δt≈N₌₀*ln 2/T_{1/2}=−B*ln 2/(A*amu*T_{1/2}), also then the energy differential in 1 kg, i.e. energy density:

W=|ΔE/Δt|=Q*Evj*ΔN/Δt=Q*Evj*B*ln 2/(A*amu*T_{1/2}), where Evj is the joule per eV energy: 1.602*10⁻¹⁹.

Inserting all constants to above formula, and calculating expression then reducing to one constant, we get a convenient formula:

$$W = 6.688 * {10}^{7} * \frac{B * Q}{A * {T}_{1 \text{/} 2}} watt \text{/} kg ,$$

just to redeclare the unit: Q is eV (electron-volt), T_{1/2} is s (second), A, B are dimensionless.

Considering beta decay will waste about 40% energy in neutrinos, thus above formula should be corrected to:

$$W ( β ) = 4 * {10}^{7} * \frac{B * Q}{A * {T}_{1 \text{/} 2}} ,$$

but no need of correction for alpha and gamma decay. Now let me calculate the energy density of natural potassium, as only isotope 40K is radioactive with abundance B=0.0117%, Q=Q(β)=1.504 MeV=1,504,000 eV, T_{1/2}=1.251*10⁹ years=3.94*10¹⁶ s, λ=40.96, therefore W=4.58*10⁻⁹ watt/kg=4.58 nw/kg. For enriched 40K, the energy density will be greatly increased to 38 μw/kg.

Another example is the widely used strong radioactive pure isotope 60Co of cobalt: Q(β−)=2,822,810 eV, T_{1/2}=1925.28 days=166,344,192 s, λ=60, so W=11,313 watt/kg=11.3 kw/kg, really powerful! Isn't it? Of course, such 1 kg chunk of 60Co will be spontaneously ‘burning’ anywhere and anytime with hot shining surface for at least 5 years.

Now considering relative computation, let natural potassium K as baseline, for contrast, I can deduce out relative energy density of other natural radioactive elements. Assuming X_{W}=energy density ratio to potassium K; X_{A}=atom mass ratio to K; X_{B}=abundance ratio to isotope 40K; X_{Q}=decay energy ratio to 40K; X_{T}=half time ratio to 40K, then

X_{w}=X_{B}X_{Q}/(X_{A}X_{T})

For examples: Rubidium, of 87Rb beta decay, X_{W}=4.75 times stronger than potassium; Lutetium, of 176Lu beta decay X_{w}=1.44; Uranium U, of 238U alpha decay X_{w}=2140; Thorium Th, alpha decay X_{w}=662; Rhenium, of 187Re beta decay, X_{w}=0.07; Lanthanum, of 138La beta decay, X_{w}=0.035; Indium, of 115In, X_{w}=0.003; etc.

### § 12. Will Some Specific Nuclear Isomers be Next Potential Nuclear Fuel?

Nowadays, uranium 235U is the only commercial nuclear fuel, but its resource is limited, so that humankind should find next candidate elements and utilization methods.

As aforementioned, for 60Co, it has amazing high energy density 11.3 kw/kg, but unfortunately it is too expensive and not feasible for commercial nuclear fuel, because its natural abundance is zero, and it can only be man-made with accelerator or brooded in fission nuclear reactor.

It is one brilliant point of hereby my inventions that a new type of nuclear fuel can be chosen from those stable elements with not low abundance and isomer state of low energy level at which state there is significant branch ratio of greatly shortened half time beta decay.

For example, the dirt cheap element cadmium, of isotope 113Cd, its sibling abundance 12.22% is decent, and still stable, though it undergoes extreme slow beta decay at half life 7.6*10¹⁵ years, however it's yrast isomer of 263 keV undergoes only 14.1 years beta decay with 99.86% branch ratio versus 0.14% gamma decay to its ground state, such a fact suggests energy density of pure 113Cd isomer is:

W_{113m-Cd}=4*10⁷*586140/(113*14.1*365*24*60*60)=466 W/kg.

This is not bad result: for a regular family house, 10 kg 113Cd isomer is probably enough for daily use and winter heating and hot water.

In fact, not too much choice for this kind of potential fuels, other elements: 115In, 176Lu, 180m-Ta.

The 180m-Ta is the only naturally existing isomer isotope of tantalum with sibling abundance merely 0.012%, and it is perched at 77 keV energy level above 180Ta ground level at which the half life is only 8.154 hours. By ‘shaking off’, 180m-Ta can ‘fall’ down to ground state, then quickly decay to either 180Hf at 85% chance or 180 W at 15% chance with max total energy 923 keV release. Compromised by its low abundance, its energy density is only: 838 W/kg, unless enriched to pure for the max 7 MW/kg.

For indium 115In with abundance 95.71%, its isomer state: 336 keV, β branch ratio 5%, half life 4.486 hours, hence, its energy density is calculated out: 898 kW/kg.

For lutetium 176Lu with abundance 2.59% (not bad but not decent), its isomer state: 122 keV, 3 branch ration 100%, half life 3.664 hours, hence its energy density is calculated out: 23 MW/kg.

Do not cheer too early, because pushup from ground state to isomer state is not free! Among all those choices, the lowest excitation energy is 122 keV of lutetium 176Lu, but this rare earth element is not cheap: its current price is about 35% of gold.

There are many methods to excite nuclei to isomers: coulomb excitation, neutrons scattering excitation, photons excitation, neutrinos excitation, etc.

All excitations consume energy except by free solar or deep space neutrinos excitation, just like as the Parkhomov experiment with 60Co sitting at the focus of astronomical telescope.

Considering the energy consumption of excitation and efficiency, all above calculated isomers energy density should be discounted in large scale, embarrassingly, even the situation of no commercial value could occur if too low efficiency of excitation by non-free energy, such as coulomb or photons excitation.

As high energy neutrinos almost no refractive effect, and unconverged neutrinos almost useless, hence the higher the excitation energy, the lesser likely it could be excited by neutrinos.

The 122 keV of 176Lu is relatively easy to be met by converging neutrinos, and it is very close to the 58 keV of 60Co that is already confirmed of neutrinos excitation by Parkhomov's experiment, hence 176Lu is the most hopeful choice for potential nuclear fuel based on greatly expedited isomer beta decay.

Rubidium isotope 87Rb (sibling abundance 28%) seems another candidate as its decay energy Q(β−)=282 keV is locked by merely ΔJ=3 angular quanta that is less than 7 of 176Lu or 4 of 115In, and the focused low energy neutrino-ray is easy to unlock it. Anyway, I need more experiment time to confirm it. Although rubidium family abundance (natural resource deposit) is quite decent, currently it is very expensive because the low market demand results in low mining activity.

By the way, I even guess that UFO harvests energy of remote star neutrinos to sustain interstellar travel. Don't believe the fabulous daydream theory of Dyson sphere, as it is just a gedanken experiment.

### § 13. Which Elements can be Candidates of Concatenating ββ Decay Fuel?

Although we have limited feasible choices for β fuel, such as 176Lu, however more alternative candidates are always desirable and worthy to explore.

Many isotopes have potential of double β decay that is regarded as a single burst event of simultaneously emitting 2 electrons or positrons, unfortunately half life is too extremely long time to be nuclear fuel if no way of decay acceleration. By the way, Majorana 0vββ researcher's enthusiasm is still highly motivated by non-energy interest in pure theory.

I do not care about Majorana pure theory, I only care about energy. Fortunately the branch ratio of regular non-0vββ (e.g. 2vββ) is far greater than the extreme unlikely 0vββ.

With the help of focused neutrinos and other special means, some of those 213 isotopes can be outstood for fuel, provided it becomes possible for 2 sequential events of concatenating β₁β₂ with total energy Q(β₁)+Q(β₂).

Studies show that Q(β₁)<0 & Q(β₂)>0 is the mainstream property amongst all natural existed 213 isotopes, except calcium 48Ca & zirconium 96Zr which Q(β₁) & Q(β₂) are both positive, but nothing is worthy of sensational celebration even both separate betas are energetically possible, because high spin lock does block the first beta decay, i.e. the first step is crippled.

As focusable neutrinos are very low energy, if the first beta wish to be catalyzed, then the absolute |Q(β₁)| should be as low as possible, as well as the nuclear first energy level E₁ cannot be too high.

The E₁ of 48Ca, 96Zr are 3831 keV, 1581 keV respectively, such high excitement energy obviously spoil the willful neutrinos catalyst.

Perhaps most eminent isotopes are molybdenum 100Mo, selenium 82Se, and cadmium 106Cd with Q(β₁): −169 keV, −97 keV & −195 keV respectively, especially all their Q(β₂) are about 3000 keV that can in turn catalyze next β₁ decay by fast electron coulomb excitation. More importantly, all their parameters of half life of second beta decay is very short: 15 seconds, 6 minutes (via isomer) & 24 minutes respectively. Of those, the 106Cd is in style of electron capture then positron ejection (ECβ+).

Fearing negative Q(β₁), eh? No worries. Even unfocused neutrinos charged current can supply enough energy to make this large endothermic reaction occur:

p⁺+=v̅+e⁺−1.29 MeV

In 1956, the Nobel laureate Frederick Reines & Clyde Cowan had set up experiment to prove above reaction true provided the threshold energy of antineutrino is larger than 1.29 MeV+positron mass=1.8 MeV, though the cross section is extremely small.

Now that we can focus low energy neutrinos, of course, overcoming Q(β₁) a few of hundreds keV is not big deal, and surely exponential high cross section is expected. Moreover, as the half life of ensuing β₂ of well-selected fuel is very short, the quasi-instant gained Q(β₂) circa 3 MeV is capable enough to pay back the Q(β₁) debt, and such a positive feedback can further catalyze next β₁ by coulomb excitation or Bremsstrahlung photon excitation.

As to reaction equations for educational purpose, here exampled in the 100Mo:

100Mo→100Tc−169 keV, catalysis of focused neutrinos is needed.
100Tc→100Ru+3204 keV, t_{1/2}=15.46 s.

Interestingly & favorably, the intermediate product technetium 100Tc can only exist a very short moment, not only that, but in fact, none sibling of isotopes of this element family can still survive in current universe, i.e. family abundance=0, what a revelation of possible nuclear fuel!

For traditional fission fuel 235U, roughly output 1 MeV energy per nucleon, in contrast, β or ββ fuel is roughly 20 keV per nucleon, obviously far lesser, but the great advantage is that such ideal clean energy actually features decent energy density, no risk of both nuclear proliferation and waste radioactive pollution! Of course, as the low abundance of the wanted isotopes, enrichment process is also highly preferred for commercial reactors provided costs is marginally worthwhile for profitable energy production.

Philosophically thinking, a reasonable proportion deducted from the released energy of every beta decay, can be regarded as an intended mutual-aid “tax” levied by the Great Nature in form of any distance reachable neutrinos for cosmic welfare, because in His mercy, everywhere is created equal and should be accessible of Prometheus-like igniter for energy production.

More experiments, theoretical analysis and calculation are needed for reselection or verification. Perhaps there is only last mile to success in my current ββ fuel experiments.

If thou or thy entity hath surplus disposable fund, why not to follow the goodwill of the Great Nature? I do need financial support to deeply explore all possible nuclear energy for humankind future, but my current deplorable status quo is not viable, despite of bearing ambition to make America great again and drive world civilization great breakthrough! As a quid pro quo, due credits and returns will be earmarked for thy generous contribution in hilarious celebration of the final great successes.

Textbooks assert that decay rate is invariable. However, science discovery and technology innovation are always advancing, therefore “Do not let anyone tell you it cannot be done”, the president Trump's voice is still resounding.

Thanks for Donald Trump's resplendent philosophic gedanken and renewal call of American spirit to encourage me continuing this unblessed & unfunded kind of lonely energy research, otherwise I have never any chance to approach success so closely until now.

Once success in ββ nuclear fuel, I will declare it in my twitter @kiwaho, just follow me now.

### § 14. How to Artificially Produce Neutrinos or Antineutrinos on Demand?

Relying on natural radioactive elements to produce neutrinos? Not good idea, it is too low dose, because of the usual super long time half life.

Relying on solar neutrinos? Sounds good and almost decent dose, but neutrinos spectrum not adjustable unless human beings could modify or engineer the Sun, and we have to mechanically track the Sun 7×24 full time, by taking advantage of climate zero influence, unlike harvesting solar photovoltaic energy only from sunshine.

Modern science never tells us how to get high dose of neutrinos beam in cheap means, except by expensive high energy particles collision via accelerator.

My scientific research shows it is possible to get decent dose of low energy neutrinos beam by sudden decelerating or braking high speed linear flying electrons in electric field.

Do not be confused with Bremsstrahlung radiation—photons emission that only occurs in angular braking, that means electrons must fly in curved path.

Modern science asserts only electric recharging effect occurs when electrons fly in the same direction with electric field vector between 2 electrodes of power supply, i.e. electrons are being decelerated therein.

But in my theory, there are 2 results simultaneously occurring, one is the recharging effect, the other is neutrino and antineutrino pair production, and the direction of moving neutrinos & antineutrinos are in the same direction with electrons.

In other words, neutrino or antineutrino in electron flavor is just the tiniest constructional component of an electron.

Even seemingly emitted from nucleus while β− decay, neutrino and antineutrino should still be regarded as ready-fragment of electron before the electron breaks through and is braked by the “outer wall of nucleus” or so-called coulomb barrier, thereby only antineutrino gets out along with the β− particle, i.e. the electron with tiny mass loss duo to ripping of neutrino-antineutrino pair, but neutrino is just absorbed by the “wall”, or say, the host nucleus of the proton that has just launched the electron.

The above analysis on β− & antineutrino decay can conjugatedly apply to β+& neutrino decay, where “conjugatedly” means by logic mapping: electron to positron, β− to β+, antineutrino to neutrino, proton to neutron, etc.

Whatever angular or linear braking, the direction of emitted photon or neutrino-antineutrino pair is analogue to unseatbelted passenger's forward inertial jerk during a sudden brake of vehicle, as neutrinos and antineutrinos can be regards as “passengers” of electrons.

Modern synchrotron radiation experiments have proved that photons are emitted from the tangent forward direction of the donut-like accumulator ring of high energy electrons.

Modern experiments on MeV to GeV-level manmade neutrinos have also proved the neutrino's or antineutrino's direction complying with my theory.

Although the end velocity of electron is same for different intervals between electrodes whilst same acting voltage, the order of magnitude of acceleration does matter, only over certain threshold value, can neutrinos-antineutrino pair be thrown out. The value of acceleration:

a=qₑ*E/mₑ=qₑ*(V/d)/mₑ

where a is acceleration, qₑ standard charge, E electric field strength, V acting voltage, d electrode's distance, mₑ electron mass.

My study shows that minimal acceleration should be 2.13*10¹³ m/s²=2.2*10¹² g, where g is the earth gravity acceleration 9.8 m/s², and at this acceleration, only ultra cold lightest neutrino, of course, undetectable like as dark matter, can be born, its total energy include rest mass is about the cosmic background radiation, i.e. 2.726K or 0.000235 eV.

As such cold neutrinos useless, so it is necessary to ante up at least 10 thousand times on the minimal acceleration in reality. In contrast, angular acceleration of orbital electron of hydrogen atom is 9.2*10²¹ g, and exponentially reduced for electrons in accumulator ring of synchrotron.

No wonder even the super long high energy LINAC accelerator, such as the famous 3 km long SLAC, cannot produce neutrino-antineutrino pairs, as in fact its sectional electric field strength is still not enough high to meet the threshold of acceleration, though its end energy is accumulated so high.

As this is not the place to write monograph, so herein more details about how to deduce above data is omitted.

For low energy neutrinos production, voltage cannot be too large, so technically, the linear braking distance is very tricky, i.e. how fast to stop electrons, the more sudden or instant the braking action, the more higher the energy of neutrino-antineutrino pair and its production rate.

The fact that β decay induced neutrino has on par energy with associated electron should thank the extreme short braking distance in femtometer level, i.e. the radius of coulomb barrier virtual sphere surrounding nucleus.

In fact, not only linear braking, but also linear speeding by electric field (not by collision) can produce neutrino-antineutrino pair, and in case of speeding, the pair's direction is opposite to electrons flying direction. All analysis on braking induced neutrino-antineutrino pair can conjugatedly apply to accelerating induced one.

Although shortening distance of either acceleration or deceleration can benefit pair generation of neutrino-antineutrino, however shortening distance of acceleration should pay the cost of power input rate, hence If pursuing both ends, it will be prohibitedly expensive, that is why emphasis only on braking induced neutrinos is enough.

Strictly speaking, it is not my theory that linear braking electron can produce neutrino, but the lemma of the virial theorem in current textbooks.

Remember how is the classic radius 2.82 fm of electron deduced? Indeed, the virial theorem is applied thereby to the imagined transition of electron-positron head-approaching mutual acceleration, which is proceeded with the gradual “evaporation” of electron's mass by some unspecified radiation, so as to facilitate linear acceleration, as well as counterbalance the reduction of potential energy of electric field, i.e. to honor energy conservation.

Anyway textbooks do not claim what type of radiation, but obviously it is not photon, because boson photon can only occur in angular braking or angular speeding, so we have to assert the unspecified radiation is fermion neutrino.

Because the minimal emission is one pair of neutrino & antineutrino for one stopped electron, hence, the max energy is 0.5Vc eV, where Vc is the applied voltage between electrodes, e.g. a regular 1.5V battery may get 0.75 eV neutrino at max energy.

If considering recharging energy to the power supply during electron deceleration, the max energy of neutrinos should be further discounted. As no accurate record, just speculatively yet reasonably assuming 50/50, hence the max energy of neutrinos is probably 0.25Vc eV.

Just like nuclear beta decay, the artificial neutrinos are also in continuous distribution of energy spectrum from 0 to the aforementioned max, and the mean value is likely 0.1V_{c} eV.

The advantage of such artificial neutrinos source is with energy spectrum adjustable and super low energy reachable by simple regulation on acting voltage and electrode-spacing.

The reaction equation can be described by:

e→e′+n*(vₑ+vₑ)+Q

Here e=electron with larger energy, e′=linear braked electron with lower energy, n=arbitrary integer number, vₑ=neutrino with electron flavor, v̅ₑ̅=antineutrino with electron flavor, and Q=recharging energy to power supply.

Theoretically above equation meets all conservation laws, e.g. energy, linear and angular momentum, lepton, baryon.

Angular momentum conservation does impose restriction on directions of neutrinos and antineutrino, i.e. they must fly in same direction so as to cancel their angular momentum, because the neutrino's chirality is left-handed, and antineutrino is right-handed.

In future, if Majorana conjecture is confirmed, i.e. neutrino and antineutrino is same particle in chirality and other aspects, then neutrinos and antineutrinos must fly oppositely, but thus far all experiments do not support the conjecture.

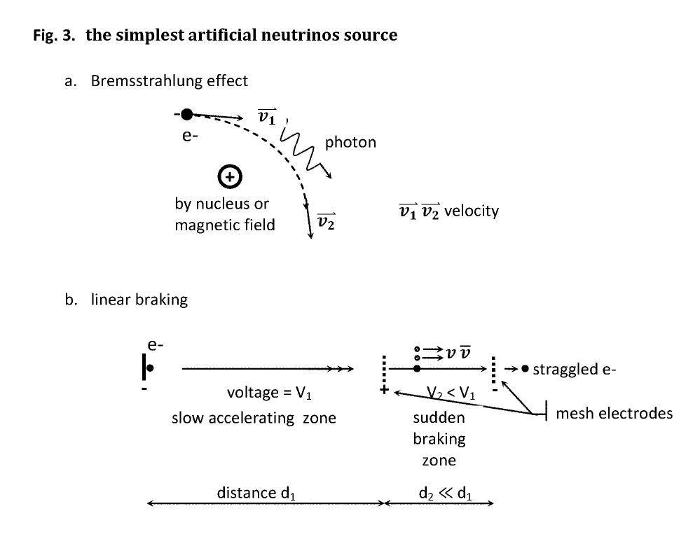

The FIG. 3 with two sub-figures illustrates how to brake fast moving electron in angular and linear ways with different radiation particles: sub-FIG. 3a for photons vs. 3b for neutrinos.

The first sub-figure shows how a photon is produced by angularly braking on a flying electron, and this is also referred as Bremsstrahlung effect. Both a nucleus and magnetic field can angularly brake electrons. Photons will emit along the tangent direction. The velocity vectors are drawn at two points: prior and posterior to photon emission.

In the second sub-figure, the distance d1 is arranged quite long to steadly accerate electrons so as for neutrinos production, but d2 short enough for sudden braking so as to emit neutrino-antineutrino pair. As to the deceleration voltage V2, it should be less than acceleration voltage V1 to prevent from midway return. The braking voltage is applied to two mesh or sieve electrodes, so as let the straggled electrons pass through.

There is a challenge problem: how to separate neutrino or antineutrino from mixed ray? If this problem not fixed, then the mixed ray mainly excite nuclei to higher energy level via neutral current energy attenuation, though catalysis still functions in so-so extent, but the more important charged current catalysis may not work because of cancellation each other.

Currently the needed filter is still under research for resolving above challenge.

### § 15. What is Deference of β Spectrum Between Neutrino-Catalyzed & Natural Decay?

Natural beta decay:

X(Z)→X(Z+1)|X(Z+1)*+e⁻+v̅ (electron ejection), or

X(Z)+e⁻→X(Z−1)|X(Z−1)*+v (EC, i.e. electron capture), or

X(Z)→X(Z−1)|X(Z−1)*+e⁺+v (positron ejection),

where asterisk (*) means excited state, “I” is OR operator, means to choose one from two possibilities (ground or excited state).

Neutrino-catalyzed decay:

ν+X(Z)→X(Z+1)|X(Z+1)*+e⁻ for charged current absorption, or

ν+X(Z)→X(Z+1)|X(Z+1)*+e⁻+v̅+ν′ for neural current damping.

Antineutrino-catalyzed decay is similar, but it is not economic because it relies on nearby regular fission reactor, not the free Sun, hence just ignore it.

Comparing above 2 categories, it is clear that: In former, the decay energy Q(β) is shared by and distributed to electron and antineutrino as per Gaussian bell probability distribution function;

In latter, there are 2 possibilities: electron get all Q(β) plus neutrino incident energy, or a regular decay spectrum but endpoint energy is boomed by an increment that equals to the reduced energy of neutrino.

The excited state will quickly fall down to ground state via gamma decay, especially neutral current neutrino-catalyzed decay has higher chance of delayed gamma decay than others.

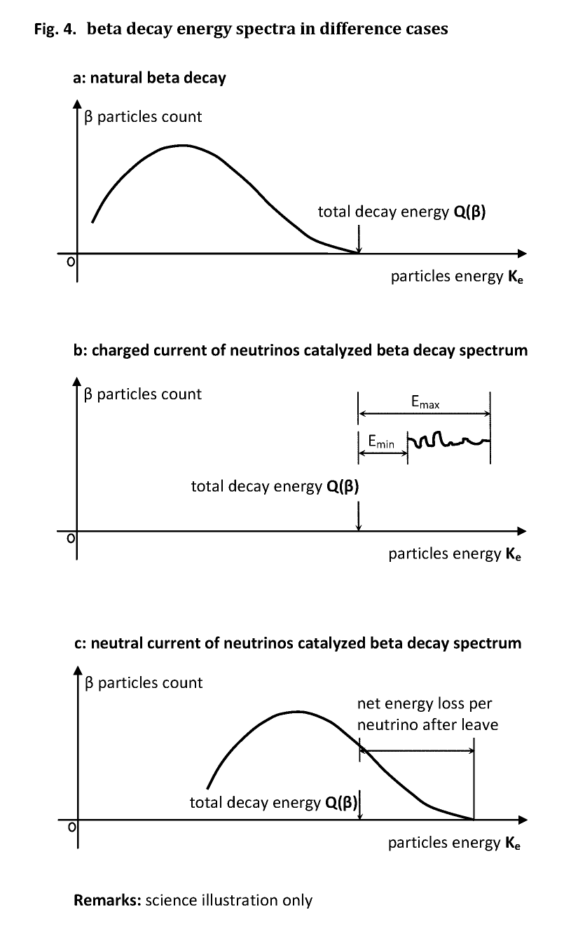

FIG. 4 shows the vivid beta energy spectra with three sub-figures: sub-FIG. 4a for natural beta decay; sub-FIG. 4b for charged current of neutrinos-catalyzed beta decay; sub-FIG. 4c for neutral current of neutrinos-catalyzed beta decay.

The curves in this figure represent the general statistical results, and the rough shapes & trends make more sense than a transient value. The horizontal axis stands for the beta particles kinetic energy Kₑ, and the vertical axis for the statistical number N of beta particles. The mentioned Q(β) is the total beta decay energy.

The sub-FIG. 4a is nothing of special as a regular beta decay spectrum curve; the sub-FIG. 4b is drawn under the assumption of no emission of delayed gamma photons, and Eₘᵢₙ Eₘₐₓ denote respectively minimal and max energy of neutrinos; the sub-FIG. 4c is drawn under the assumption of only one decay channel, and it illustrates the simple curve shift caused by the impact of neutral current of neutrinos, the shifted span is just the net energy loss per neutrino after leave.

### § 16. Ergodic Bunimovich Stadium Geometry

To maximize the efficacy of neutrinos, one of my inventions features special nuclear fuel geometry form factor or encapsulation: Bunimovich stadium capsule.

The Bunimovich stadium is the name given to any area comprising a rectangle bounded at both ends by semicircles.

Mathematically this geometry can enable an endlessly edge-rebounding billiard to cross all points inside the area; this property is also called ergodicity.

In nuclear reaction, cross section is always precious. Cross section will be increased tremendously if a useful moving particle can stay inside fuel as long time as possible.

Neutrinos are useful for beta decay, and low energy neutrinos show both refraction and reflection on media interface. Especially the lower energy the neutrinos, the higher refractive index, easy above 2.0+, that means total internal reflection inside fuel is far easier than refraction of leaving fuel.

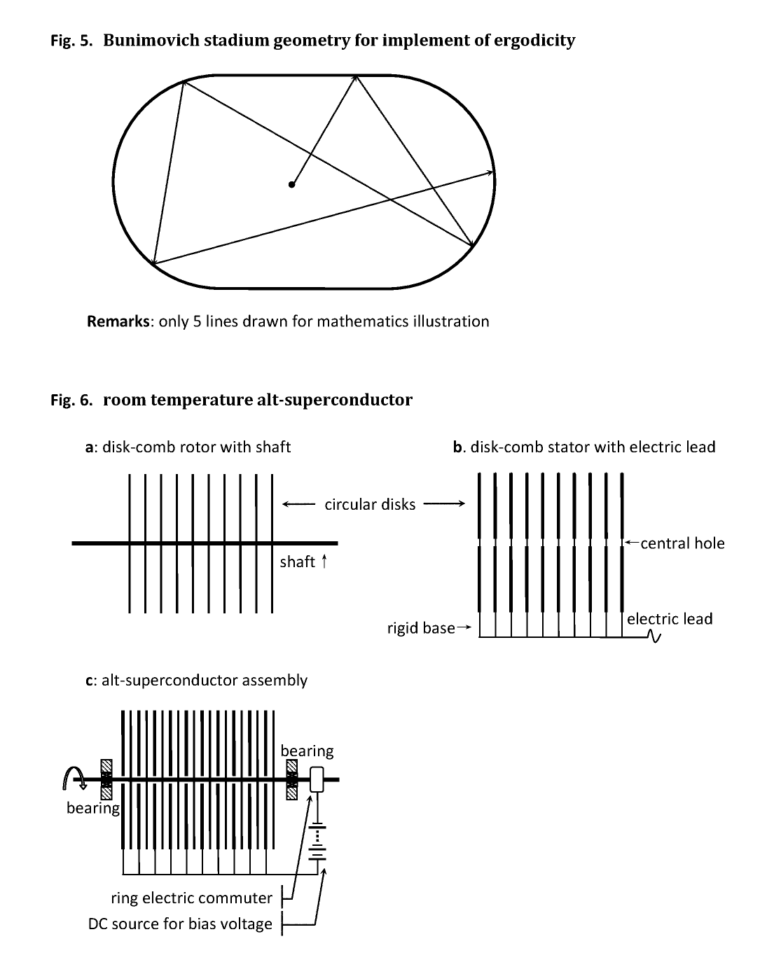

The FIG. 5 illustrates the Bunimovich stadium geometry, where the billiard is represented by the solid black dot, and will go through almost averagely all points inside the area after enough long time reflections, though only 5 lines drawn for mathematics illustration.

### § 17. Collective Low Energy Nuclear Reactions (Transformation)

Under extreme magnetic field and necessary exciting energy, two and more atoms can transform new atoms with circa keV level energy transaction per collective reaction that is significant more than regular chemical reaction but far less than regular nuclear reaction.

For examples:

Li⁷+Ni⁶⁰+2H¹→N¹⁵+Mg²⁵+Si²⁹+437 eV (without electron involvement)

Ti⁴⁸+2Ar⁴⁰+O¹⁶→N¹⁵+Cl³⁷+Ar³⁸+Cr⁵⁴+2.67 keV (ditto)

2Ti⁴⁷⁺²Ar⁴⁰+C¹²→O¹⁶+S³⁴+Ca⁴⁶+2Sc⁴⁵−5.13 keV (endothermic)

V⁵¹+Ti⁴⁸+O¹⁸→Fe⁵⁷+Na²³+Cl³⁷+e+883 eV (analog to β−, but multibody collective reaction)

5O¹⁶+2C¹²+e→Na³+2H¹+2N¹⁵+Ne²⁰+Si²⁹+1 keV (analog to EC, but multibody)

The scientists D. V. Filippov and L. I. Urutskoev pioneered the theory and experiments research (ref. 10), and they named above reactions as transformation, or C-LENR (Collective Low Energy Nuclear Reaction).

They observed the nuclear transformation of chemical elements on a macroscopic scale (10¹⁹ above nuclei per shot) in their titanic foil electric explosion experiments. Specifically, the transformation of isotope 48Ti yields rather wide spectrum of chemical elements that result in a substantial distortion (˜10%) of isotopic ratio in the remains of titan. Many other teams successfully replicate the experiment independently.

The first 3 of 5 reactions seem that all neutrons and protons of reactants are just re-kneaded in order to form other new elements, but in the last 2 reactions, a neutron (or proton) in some uncertain atom decays to proton (or neutron) with emission of electron and antineutrino (or electron capture and neutrino).

Not like the LENR, here C-LENR is not necessarily always exothermic, e.g. the 3^{rd} is endothermic.

In other words, the first 3 are strong force nuclear reactions that neutrinos catalysis does not work, but the others are electroweak reactions, and supposedly the former should be quite easier than the latter.

The regular beta decay is single nucleus natural “burning”, and large angular momenta change is difficult to levy on daughter particle, that is why spin lock is easy to frustrate beta decay; but in multibody beta decay, existing lots of momenta undertakers, hence supposedly such special beta decay should be easier.

As to the underlying theory, the theoretical physicist Harald Stumpf proposes that the phenomenon may be resulted from symmetry breaking by electric discharge in water and formation of light magnetic monopoles in an extended standard model (ref. 11).

But one question is still not yet answered: how the re-knead processes overcome the coulomb barrier? For example, in experiment of water-immersed titanium foil explosion, the discharge voltage is only 50 kV, so the energy of accelerated protons is supposedly less than 50 keV, and obviously less than the regular MeV level coulomb barrier.

The answer may be addressed by the EV (Electron Validum) theory proposed by experimental physicist Kenneth Shoulders (ref. 12). Just like as my theory of multiple even number neutrinos binding to quasi-particle boson with high spin, he believed that a large cluster of electrons can be “compressed” densely into his EVO (Exotic Vacuum Objects) quasi-particle with super strong electric field that can power protons to MeV level, though I doubt how the coulomb repulsion is accidently weakened.

Obvious heat anomalies in experiments or isotope distribution shift suggest that: the cross section of such nuclear transformation is almost equivalent to or near matchable with regular chemical reaction.

In fact, electric current induced nuclear reaction can be divided into 2 classes: the first is the gentle class, i.e. the low voltage electrolysis class, and another is the violent class, i.e. the high voltage pulse discharge class.

The gentle class has been widely studied with the fruits of a handful of new theories & conjectures for decades and decades in cold fusion republic since 1989, the palladium cathode plus heavy water solvent is the most typical one. This class did always report excess heat observed more or less.

Of this class, only a few of configurations may be caused by C-LENR, such as carbon electrodes+water circa 10 VDC/5 A arcing (ref. 13), in my point of view, could go with the afore-listed 5^{th} equation at least. But flowing chemical exothermic reaction must also take quite proportion of the anomalous heat (because its cross section is extremely larger than nuclear reaction):

C+Ω₂→CO₂+4.1 eV (i.e. 393.5 kJ/mol)

The violent class that executes high voltage pulse discharge from hobbyist' kV level to Sandia's Z-pinch MV level, is relatively less studied and reported. In my experience, this class does not always have anomalous heat output, and depending on the choice of electrode materials, even energy deficit can happen because of possible endothermic C-LENR, so this class may be only good to precious element synthesis by so-so HV (High Voltage), or orthodox hot fusion by top HV, or direct mechanic energy output by mediocre HV.

When studying water arc explosion, the famous scientist Peter Graneau have found anomalous excess mechanic energy output of exploding water fog, but unfortunately he was not aware of something to do with nuclear reactions (ref. 14).

Perhaps due to his random but lucky pick of right material for electrodes, otherwise, no excess energy would be seen, just like the unlucky Canadian engineer George Hathaway who failed to copycat that experiment, and then rebutted Graneau's claims (ref. 15).

Even both of them picked copper as electrode, it is still hard to say which guy is lucky because not every copper conductor was created equal and even minor impurity does matter.

Anyway, by numerous experiments and time and time again failures, I have discovered the perfect configuration of electrode materials and solute that can make very high COP (Coefficient Of Performance) of water arc explosion.

### LITERATURE REFERENCES

1U.S. patent application Ser. No. 15/267,122, “dielectric blade comb piston unlimited voltage generator, fusor and more”, filing date 2016 Sep. 15.
2. Neutrino coherent forward scattering and its index of refraction, Jiang Liu, DOI: 10.1103/PhysRevD.45.1428.
3. Gravitational focusing of cosmic neutrinos by the solar interior, Yu. N. Demkov and A. M.

Puchkov, 2000 Physical review, DOI: 10.1103/PhysRevD.61.083001.
4. Neutrino and graviton rest mass estimations by a phenomenological approach, Dimitar Valev, preprint arXiv:hep-ph/0507255.
5. First Indication of Terrestrial Matter Effects on Solar Neutrino Oscillation, A. Renshaw et al, 2014 Physical review letter DOI: 10.1103/PhysRevLett.112.091805.
6. Changes of decay rates of radioactive 111In and 32P induced by mechanic motion, He YuJian et al, DOI: 10.1007/s11426-007-0030-z.
7. Can the decay rate of 32P be changed by mechanic motion? Ding YouQian et al, DOI: 10.1007/s11426-009-0012-4.
8. Deviations from Beta Radioactivity Exponential Drop, Alexander G. Parkhomov, DOI:10.4236/jmp.2011.211162.
9. Hidden Variable Theory Supports Variability in Decay Rates of Nuclides, Dirk J. Pons et al, DOI:10.5539/apr.v7n3p18.
10. On the possibility of nuclear transformation in low-temperature plasma from the viewpoint of conservation laws, D. V. FILIPPOV, L. I. URUTSKOEV, Annales de la Fondation Louis de Broglie, Volume 29, Hors serie 3, 2004.
11. Symmetry Breaking by Electric Discharges in Water and Formation of Light Magnetic Monopoles in an Extended Standard Model, Harald Stumpf, Advances in Imaging and Electron Physics volume 189, 2015, DOI: 10.1016/bs.aiep.2015.01.002.
12. Charge clusters in action, Ken Shoulders et al, www.rexresearch.com/shoulders.
13. R. Sundaresan, J. Bockris, “Anomalous Reactions During Arcing Between Carbon Rods in Water”, Fusion Technology, Vol 26, Pg 261, November 1994.
14. Arc-liberated chemical energy exceeds electrical input energy, Peter Graneau et al, Journal of Plasma Physics 63(02):115-128, February 2000, DOI: 10.1017/S002237789900817X.
15. Comment on “Renewable energy liberation by nonthermal intermolecular bond dissociation in water and ethanol”, G. Hathaway, Journal of applied physics, 2012, DOI: 10.1063/1.4748880.

### BACKGROUND OF INVENTIONS

The presented inventions are mainly in field of energy technologies, zoom-into clean nuclear energy, further zoom-into a kind of beta decay based reactor, again further zoom-into neutrino-catalyzed beta reactor.

As to the so-called alternative superconductor, strictly speaking, it is not in the field of superconductor, because its official definition is related to new material formula, but mine is only a substitute method other than synthesis of new materials to approach same or similar properties with real superconductor, specifically my method involves direct mechanic input.

The purpose of using alternative superconductor system is motivated by the frustration of high energy consumption of maintaining cryogenic environment because there is no superconductor that can work in room temperature in nowadays market.

Especially in research & development of clean nuclear energy technology, high strength of magnetic field is often needed, in turn, high electric current, such as kA even MA level, is needed, in turn again, superconductor is needed in order to reduce extreme high joule heat dissipation along wires.

In room temperature, even boiler high temperature, I discover that generating huge virtual electric current equivalent to real current in special configured circuit by high speed mechanic motion, can save more energy than applying proper voltage across a proper resistor or regular conductor, even than extreme low temperature sustained superconductor.

I also discover that low energy neutrinos can be focused by special lens made of heavy metal, and the focused neutrinos can catalyze beta decay, then unleash spin-locked nuclear energy that is at least thousandfold more powerful than chemical reaction, though %1 or so of fission or fusion reaction, former of which may risk terrible radioactive disaster if operation failure like Chernobyl, and latter of which is still immaturely under intensive research in laboratories.

It is well-recognized that energetic high spin bosons can turn forbidden transitions under rules of spin-parity selection to dominant electric or magnetic multipolarity transitions during excitation or deexcitation.

As theorized in the first section, focused neutrinos can form high spin quasi-particle bosons with broad spectra of both multiplied high energy and diversified high spin. For example, 100 neutrinos of 10 keV forge one quasi-particle of 1 MeV and spin spectrum from 0 to 50 quanta.

In my inventions, the focused neutrinos functions as “Prometheus fire” to ignite spin-locked thresholdless beta decay e.g. lutetium 176Lu etc. or first stage threshold-locked tandem beta decays such as the possible ββ fuel molybdenum 100Mo.

As every new invention has something to do more or less with my unprecedented new physics, so that enumeration of prior arts seems unnecessary or futile, because of non-existence of related inventions.

### INVENTIONS DESCRIPTION

### Invention 1: Basic Alternative Superconductor System

As per the calculation in § 1 of first section, electrons in current carrying real conductor, just runs as slowly as snail, fortunately, by other method, great advantage can be taken to virtually and exponentially increase velocity of electric charges by rotating electric charged disk(s), though only virtual electric current exists, yet still makes sense.

All current-related properties, especially the magnetic effect of virtual electric current, can gain the same one with real current, so never to depreciate virtual current.

As there is no relative motion between rotating disk base structure and metal ions on disk, the intrinsic resistance of regular conductor does not act on joule heat dissipation, so such a system can be regarded as virtual superconductor, though little mechanic energy is needed to maintain a constant rotation.

FIG. 6 with three sub-figures presents the alternative superconductor system, of course, room temperature works.

A plurality of disks are mounted on or casted as assemble with a shaft that is supported on a pair of low friction bearings at both ends; another set of similar disks with central holes are interleaved with the disk-shaft assembly in even space.

Size of the said central hole is slightly larger than shaft diameter, so as not to bring extra friction to shaft rotation.

Sub-FIG. 6a shows the disk-comb rotor with shaft. The assemble functions as abstract electrode with same electric potential everywhere when it is connected to one pole of DC (direct current) power supply via the electric commuter/collecting ring or just a bearing with good conductance;

Sub-FIG. 6b shows all other interleaved disks that are mounted and electrically connected to metal base, and this combo functions as another abstract electrode stator with same electric potential everywhere when connected to another pole of DC power supply. The Central hole, rigid base and electric lead are marked.

By setting the spacing interval as reasonably small as possible between neighboring disks, core of the whole system becomes good capacitor with decent high density of electric charges on surfaces after fully recharged.

In general, the capacitance C of planar capacitor with spacing interval d and surface area A, can be expressed by formula:

$$C = \frac{ϵ A}{d} ,$$

where ∈ is the permittivity of dielectric medium, for vacuum ∈₀=8.85*10⁻¹² farads per meter.

The density a of electric charges can be calculated by formula:

$$σ = ϵ E = \frac{ϵ V}{d} ,$$

where E is the electric field strength, V is the applied voltage across electrodes.

The higher breakdown dielectric strength the dielectric medium, then the closer the disk spacing, and usually vacuum environment is preferred in this application, because dielectric strength in vacuum is theoretically unlimited, though limited yet very high in reality.

The voltage across the electrodes is also called bias voltage, or capacitor voltage, and its polarity setting does not matter if only pursuing high virtual current, otherwise is determined by associated application.

As positive and/or negative electrodes can be mechanically driven to rotate, such an abstract capacitor is called dyno-capacitor. It is another building block in my whole dielectrodynamics theory that has been defined at first time in my previous patent application wherein a typical model is implemented with dynamic switchable multi-dielectric flakes or blades.

Sub-FIG. 6c shows the combination of sub-FIGS. 6a and 6b and some auxiliaries to form a so-called dyno-capacitor. Two bearings, ring electric commuter and DC source for bias voltage are labeled for easy understanding. The ring electric commuter is also referred as collecting ring.

As the appearance of disk-electrodes arrangement looks like a comb for hair grooming, hence disk-comb is also used as adjective to literally decorate dyno-capacitor.

The drawn pieces of disk of comb in all subject figures are just for coarse illustration, the real quantity depends on objectified system, and disk spacing & coupling should make assembled-capacitor in excellent performance.

Huge virtual electric current can be obtained without the concept of resistance as long as the rotation speed is high enough. In this sense, it looks like alternative superconductor system.

According to the Guinness world records, the manmade highest speed of revolution is 600 million rpm (revolutions per minute) rendered by a diameter 41 μm tiny ball.

Of course, that top speed is far less economical; empirically the affordable and feasible speed is under 1 million rpm.

Doing math can be more convincible for industry estimation.

Assuming super large Alfven current, i.e. 17 kA (thousand ampere) is needed, disks total 1000 pairs, radii 10 cm, let voltage high enough to get charge's density 1 e per square nm (nanometer), i.e. 1.6*10⁻¹⁹/(10⁻⁹)²=0.16 C/m².

Total area with electric charges=1000*π*0.1²=31.4 m², then total charges=31.4*0.16=5C;

The time span to turn all charges one revolution=5C/17000λ=0.00029 s, then the revolutions per second=1/0.00029=3448, i.e. 3448*60=206880 rpm.

The result rev speed seems not too difficult to reach.

Most real superconductors usually allow mediocre 2 kA, far less than 17 kA, though many nuclear physics experiments wish the super strong magnetic field induced by Alfven current.

Starting alternative superconductor system should input initial mechanic energy to establish stable rev speed, i.e. 0.5*(moment of inertia)*(angular speed)², since then, maintaining input only compensates small friction loss because of no other mechanic loads.

Rotation can be driven by whatever reasonable means, such as high speed electric motor or accelerating gearbox transmission.

To save initial input, the disk-shaft assembly is required to be as light as possible to minimize rotary inertia.

Because disks are arranged very close, and as thin as flakes, so machining accuracy is very strict.

It is highly motivated to increase density of electric charges on electrodes as high as possible for achieving high virtual current as well as lessening burden of high rev speed.

Therefore some improvements are derived.

As an electrochemical cell battery can hold large colony of charges on electrode plates, if we can rotate specified electrode plate(s), then such an improvement can be better in virtual current performance than air or vacuum dyno-capacitor system.

To distinguish from dyno-capacitor, dyno-battery is hereby defined as alt-superconductor system based on a battery frame.

Electrolytic capacitor is similar to electrochemical battery, despite only hold a fraction of charges of the same size battery.

In principle, electrolytic dyno-capacitor distinguishes itself from regular dyno-capacitor only by changing vacuum or air medium to electrolyte aqueous.

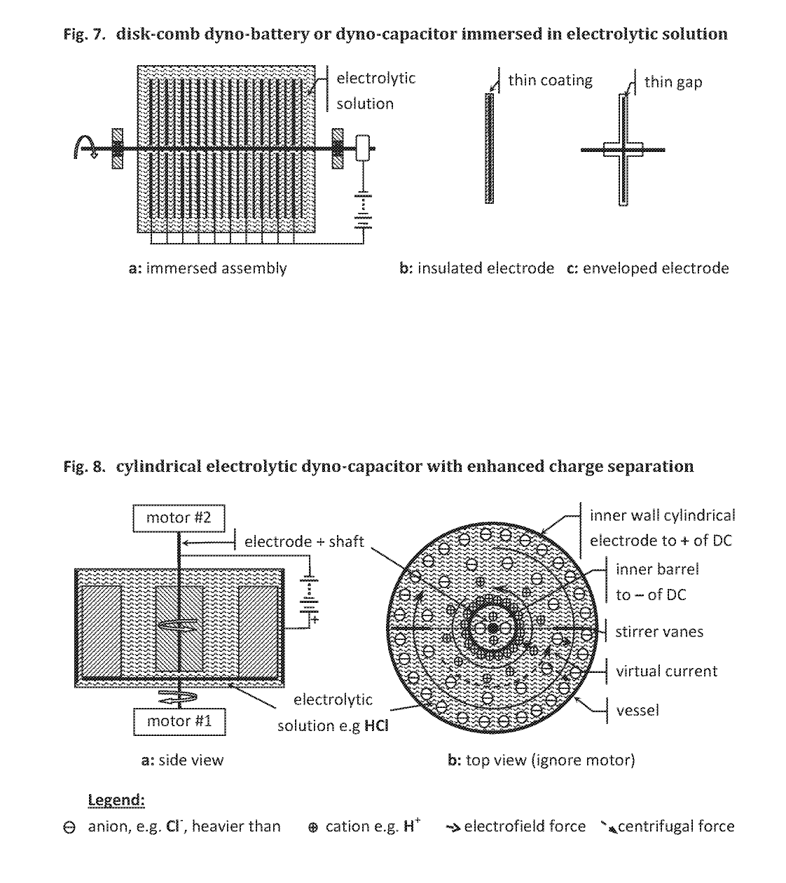

FIG. 7 comprises three sub-figures: the first is the main assembly, the others are the zoom-ins of two possible dielectric insulations for a single disc electrode.

Sub-FIG. 7a of FIG. 7 illustrates a schematic structure of disk-comb dyno-battery or dyno-capacitor immersed in electrolytic solution. The electrolytic solution is marked.

The immersed disks can either be coated as in sub-FIG. 7b with layer of or enveloped as in sub-FIG. 7c within pocket of thin dielectric medium, but coating may increase energy consumption during starting and sustaining because of viscosity, and enveloping may suffer from sealing issue though costing lesser driving energy.

The thin coating and the thin gap are marked respectively in sub-FIGS. 7b and 7c.

For rechargeable dyno-battery, a special electrochemical cell, its electrode(s) can be rotatable.

FIG. 8 illustrates a cylindrical electrolytic dyno-capacitor with enhanced charge separation: sub-FIG. 8a is the side view, and 8b is the top view.

The cylindrical container is filled with electrolytic solution, and its inner sidewall is laminated with a large area electro-foil made of anti-corrosion inertial metal, such as gold.

In sub-FIG. 8a, it can be seen that a central co-axial barrel functions as rotatable cathode driven by motor #2, and a stirrer with 2 rectangle-shape vanes is driven by motor #1, and the two rev directions are opposite.

The electrolytic solution should possesses positive ion (cation) with light mass, e.g. H⁺, and negative ion (anion) with heavy mass, e.g. Cl⁻, so as to facilitate anion to be centrifuged toward wall where electro-foil is connected to positive pole of DC power supply.

Consequently, the ion polarized distribution or separation is double enhanced by both centrifugal force and external electric field, though extra energy should pay for stirrer.

The central barrel can either be coated with low friction dielectric material such as Teflon, or enveloped with double layer cylindrical pocket so as to reduce friction.

More remarks: the setting of polarity of high voltage DC should also make heavier ion attracted towards wall; at least one electrode should be insulated for electrostatic function only; inner barrel & outer stirrer can rotate in opposite directions to make bigger virtual electric current & induced magnetic field, and stirrer's vanes should be made of nonconductor.

Sub-FIG. 8b presents rich annotation for those important things: inner wall cylindrical electrode, inner barrel, stirrer vanes, virtual current direction and the whole vessel.

A legend table is placed at the bottom of this figure for better comprehension. Graphic elements thereof are simple and intuitive.

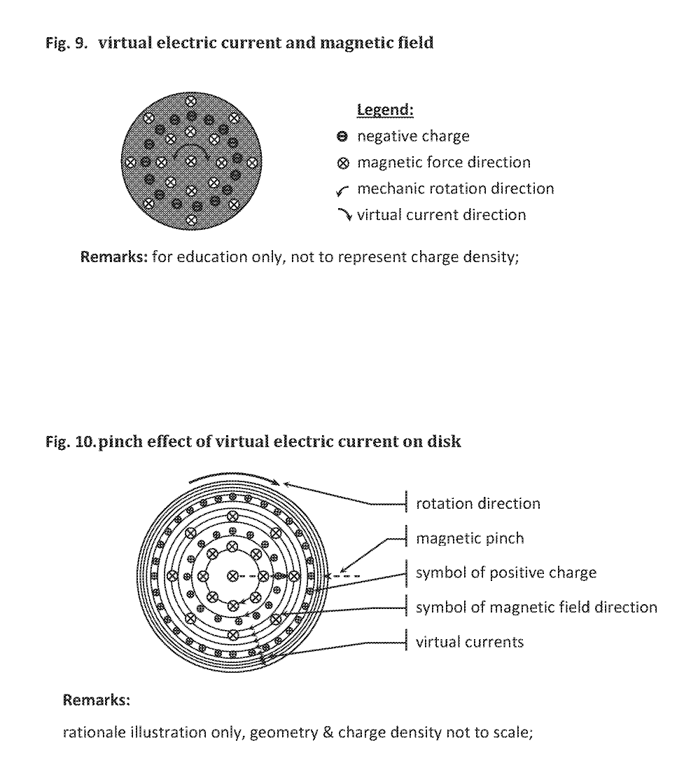

FIG. 9 illustrates the virtual electric current and induced magnetic field on a rotating negative charged disk from disk facial view. The direction of magnetic field is determined by Fleming's right hand rule, and the current direction is the counter-direction of rotation because of negative charges.

The cross-shape symbolizes that direction is pointing towards the figure laid canvas, just looks like the visual effect of seeing tail of flying arrow.

In coaxial multidisc comb of alt-superconductor capacitor, the total strength of magnetic field comes from superposition or addup of respective value induced from every disk.

A embedded legend lists four elements: negative charge, magnetic force direction, mechanic rotation direction and virtual current direction.

This figure is for education only, not to accurately represent charge density.

If disks are positive charged, then virtual current is in same direction with rotation, and magnetic field direction will toggle to opposite direction.

### The Pinch Effect of Virtual Electric Current

Same with real current, pinch effect also exists on virtual current, because both currents will induce magnetic field, then magnetic force results in pinch.

FIG. 10 shows the pinch effect on clockwise rotating and positive charged disk circular virtual current, whereby the closer to rim or edger the radial position, the denser the current, and the higher the pinch.

Pinch effect can occur not only for positive charged disk, but also for negative charged disk.

There are five essential factors annotated: rotation direction, magnetic pinch, symbol of positive charge, symbol of magnetic field direction and virtual current loops.

This figure is for rationale illustration only, so geometry and charge density are not to scale.

### Converting Virtual Current to Real Current

Virtual current can be converted to real current when the rotor is braked to stop, the charges and magnetic field are both unchanged temporarily, because intrinsic parasitic inductance prohibits current sudden change.

If rotary disk is made of real superconductor, then it will become quasi-permanent-magnet after braked and can keep long time.

Just imagine cutting a current-carrying disk into 2 pieces, high voltage will arc out spark along the cut-edges, because of air dielectric breakdown.

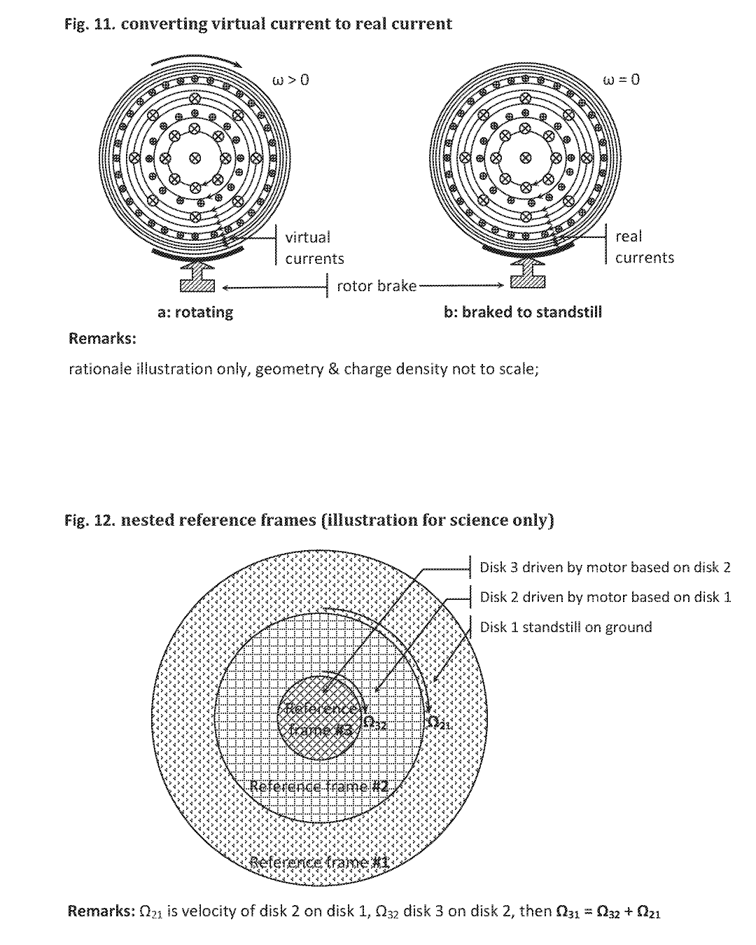

FIG. 11 shows the moments before (by sub-FIG. 11a) and after (by sub-FIG. 11b) disk is braked to standstill, where many details are presented, such as direction of virtual current and real current, magnetic field, polarity of charges, and even rough distribution of density of current caused by pinch.

In both sub-figures, the brake shoe is drawn underneath the disk rotor, and the w stands for the angular velocity. In the left sub-FIG. 11a, the current loops are marked as virtual currents, because of caused by rotation, in contrast, in the right sub-FIG. 11b where brake is applied, the temporarily sustained same current loops are marked as real currents.

After rotation stopped, virtual current becomes real current, charges, magnetic field all unchanged temporarily, because intrinsic inductance prohibits current sudden change.

If rotor is real superconductor, then it becomes quasi-permanent-magnet after braked, otherwise the real current will vanish in a regular conductor.

Also just imagine to cut current-carrying disk to 2 pieces, then, high voltage sparks will occur on cut-edge. This scenario is undrawn, but electromagnetic induction law applies everywhere.

### Boosting Virtual Current by Nesting Multiple Reference Frames

FIG. 12 presents a system of special nested dynamics reference frames #1, #2 and #3, where disk 1 is standstill on ground, i.e. the #1 stationary inertial reference frame, disk 2 is mounted on shaft of motor that is based on disk 1, and disk 3 is mounted on shaft of another motor that is based on disk 2.

When both motors (undrawn in figure, underneath disk 2 & 3) are powered, disk 2 & 3 will spin in their host reference frames with respective relative angular velocity Ω₂₁ and Ω₃₂.

If observing the motion of disk 3 across reference frames from its host #2 to #1, then the speed of disk 3 relative to disk 1 is increased to Ω₃₁=Ω₃₂+Ω₂₁.

Hence, it can obviously boost virtual current and magnetic field strength greatly, if applying this parent-child nesting system in alt-superconductor system.

The rich on-figure annotation further helps explanation on how virtual current is boosted.

### So What is the Best Application for Such Alt-Superconductor?

Of implementation of alt-superconductor system, all above means of making disk charged via embedded capacitor seems clumsy, thus good application with high ratio of output to input may be not easy to find, except special interest active magnetic field generator, though a passive permanent magnet made of rare earth could be better and cheaper.

However if radioactive material is used in alt-superconductor system, great prosperity will be looming soon.

Generally speaking, the beta minus disk can make itself positive charged naturally more or less dependent on its radioactivity because of high rate spurting electrons leaving disk surface and low rate neutralizing from ambient electrons callback, and vice versa, even in solitary parking state, though polar-arbitrary voltage biased disk embedded in capacitor can disobey this rule.

I apply this idea in next presented invention for energy production with the catalysis of magic focused neutrinos and catalysis of super strong magnetic field.

### Invention #2: Neutrino-Catalyzed Nuclear Beta Decay High Voltage Generator

In the first section, enough materials are given to prove that low energy neutrinos can be focused and that focused neutrinos possess magic power of unlocking spin-locked even threshold-locked nuclear energy.

### Lens Geometry Parameter Determination

As thereby mentioned, low energy neutrino-rays exhibit eminent refraction effect, usually with refractive index 2.0 above through heavy metals, in contrast, regular optics glass's refractive index is about 1.5 for visible light rays.

In machinability, as metals are usually ductile and malleable, but glasses are fragile, hence manufacturing neutrino lens may be relatively easy than glasses lens.

For the bi-convex lens, the focal length can be calculated by formula:

$$\frac{1}{f} = ( n - 1 ) ( \frac{1}{{R}_{1}} + \frac{1}{{R}_{2}} - \frac{( n - 1 ) d}{{nR}_{1} {R}_{2}} )$$

where f is focal length, n refractive index, d lens thickness, R₁ radius of first curvature, R₂ radius of second curvature.

### Beta Fuel Deployment and Electrode Disks Configuration

Next challenge is to seek proper beta decay nuclear fuel. This topic is also discussed in the first section. So just pick up the best choice: lutetium 176Lu.

Electrical power is high grade of energy, and thermal energy low grade, hence it is preferred to direct all energetic electrons emitted from beta decays for high grade output as max as possible.

Directing random-angled electron projectiles into managed circuit is also called rectification.

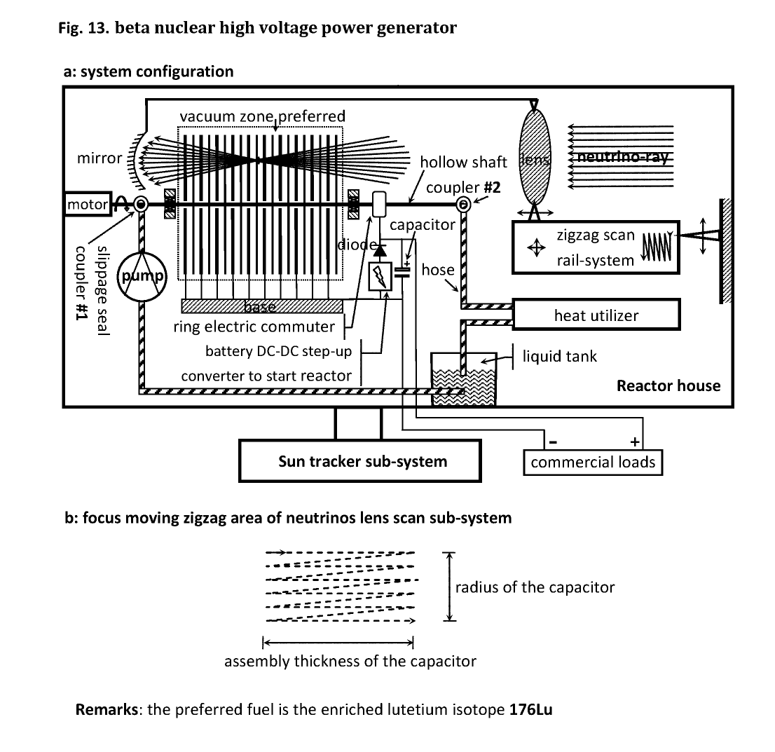

FIG. 13 shall disclose the key system implementation by a main assembly sub-figure followed with a complimentary sub-figure of neutrinos-lens X-Y scanning pattern.

Sub-FIG. 13a of FIG. 13 shows a system of beta nuclear fueled high voltage power generator.

In this invention, electron projectiles, i.e. the β particles, are departed from fuel on surface of anode, and then are directed to cathode by alt-superconductor induced magnetic field.

Because the high strength of intra-disk electric field is already properly established by and maintained as a DC power supply source, i.e. the reactor behaving as nuclear battery, and the electric field exerts drag-back force on electrons, so all β particles will be decelerated while flying to cathode, and this braking action will recharge the battery to sustain its DC output.

In best wish, all β particles are supposedly braked to a reasonable minor speed that is a little bit fast than the slow moving electrons in load-serving output cable for smooth conductor entering transition at landing points.

If reduced speed upon landing cathode is still too high, it will hit disk with random scattering and heat dissipation, else if speed is midway braked to zero, the electron will re-begin to be acceleratedly dragged back, and consume battery energy, also heat the anode.

However there is β spectrum distribution, i.e. not all electrons uniform energy, hence most electrons will inevitably experience energy trimming at cathode and result in extra heat though recharge is still the main positive effect, meanwhile, some electrons will midway U-turn to discharge battery and heat anode on a negative effect.

Only neutrinos charged current catalyzed beta decay has a relative ideal narrow flat spectrum as indicated in FIG. 4b, and neutral current does shift, but not deform beta spectrum, thus the former will generate lesser heat than the latter.

Theoretically, the U-turned electrons only produce heat in anode, because its advancing period did have recharged battery, but retreating period is now discharging in same quota, and there almost is no change of velocity at the “U's head” except opposite directions.

Principally, the heat generated in both anode and cathode is resulted by photons generated by bremsstrahlung effect while electrons scatter. Stream of such photons is also called X-ray, and here its energy should be weak or not be exaggerative if well designed.

The official output voltage Vₒᵤₜ should be prudentially set, so as to make electrical power output as high as possible in a tradeoff on reasonable ratio of electrical output to thermal output, and low percentage of U-turn electrons.

Obviously Vₒᵤₜ is dependent on fuel's decay energy Q(β), and empirically equals to 0.5*Q(β) kV, where unit of Q(β) is keV, because neutrinos roughly takes away 50% energy.

The electric commuter ring is used to transfer electronic current between rotating shaft and output terminal, so as to make official output voltage accessible to outer loads. However if bearings are made of good conductor metals, instead of using the said commuter, output terminal can directly be connected to bearing's body.

### Starting and Shutdown

To start this reactor, some prerequisites must be met:
(a) The starter power supply pre-recharges the fuel-loaded dyno-capacitor to Vₒᵤₜ;
(b) The disk-shaft assembly is driven in proper direction by a motor to a proper speed, and the speed is maintained automatically by servo system;
(c) Solar neutrinos are focused, and the focal point is inside dyno-capacitor.

The starter power supply can be the usual lead-acid battery powered DC-DC step-up module, and this module consumes battery energy only in short time while starting, since then, standby mode is entered, and its battery can be recharged by started reactor in floating mode.

The runtime output voltage may damage the inline starter DC supply module, so a diode is inserted properly for prevention from this risk.

Shutdown can be executed by turning lens 90° and braking disk-shaft assembly, hence there is no longer alt-superconductor effect and the entering neutrinos are no longer focused, then neutrino-catalysis is halted. Instead of turning 90°, moving lens side away also works because focal point is moved out of dyno-capacitor.

### Disperse Focused Neutrinos Evenly Over Beta Fuel

Because the focal point of lens is very small, and β events activity is very high around the points, hence if proper means not applied, local overheat and overconsumption of fuel will deteriorate efficiency and shorten parts service time.

A good practice is to shift focal point in a zigzag pattern on XY plane as showed in sub-FIG. 13b of FIG. 13 that can fairly treat all points on disks, one dimension of zigzag area is about the thickness of dyno-capacitor, this dimension is parallel to the optical axis; another dimension is preferred to be adjustable from small value to about the radius of dyno-capacitor, so as to control the output power.

The plane of zigzag is perpendicular to disks, and the axis of dyno-capacitor is on the extended plane of zigzag. With the constant rotation of disk-shaft assembly, zigzag scan is possible to enable focal point evenly cover all points on fuel disks.

As to the zigzag scanning velocity, there is no special requirement, so the driving power of zigzag module can be a dominant factor for consideration.

After one frame of zigzag finished, there are 2 routes to continue next frame, either directly reverse the previous itinerary in U-turn style, or jump to the same start point with last frame, also there is no special requirement for the scanning speed.

### 7×24 Full Time Sun Tracker

For full time working, the lens should track the Sun movement, and for correct tracking, the whole reactor system should synchronize with lens, so at least this way works: housing the reactor including lens in a compact module wherein the zigzag sub-system is embedded inside, then let the Sun tracker sub-system drives it.

Obviously there are 2 IRFs (Inertial Reference Frame): #1 is the Earth or ground, #2 is the inside space of module that is nested in #1. Moveable lens runs in #2 IRF, and tracker runs in #1 IRF.

In order to prevent from unnecessary neutrinos absorption, the housing materials can be chose from woods or light metals, such aluminum, magnesium or their alloys.

The tracker rotates one circle 360° per 24 hours for tracking Sun, while the commercial loads usually are stationary, so the output DC cable should be designed to prevent from kink.

### Improvements or Varieties on Neutrinos Optical System

As stated in § 9 of first section, low energy neutrinos can also be reflected, hence a mirror can be deployed at another side of dyno-capacitor, so as to reflect back neutrinos and double the catalysis effect.

The shape of mirror is spherical, and the spherical center is supposed to coincide with focal point of lens. For synchronization, mirror and lens should be in rigid linkage, so as to move together during zigzag scan.

The mirror should be polished for good reflection, and silver can be electroplated with proper thickness on base substrate, or make mirror with pure silver for best performance.

As so complicated, let a summary be on all key components in sub-FIG. 13a: Reactor housing unit sitting on Sun tracker sub-system; vacuumed dyno-capacitor with embedded nuclear fuel+supporting bearings & base; neutrinos mirror; neutrinos lens; zigzag scan rail system for lens; motor+battery backed auxiliary high voltage DC-DC step-up converter+diode+capacitor for starting the dyno-capacitor; ring electric commuter; liquid tank for buffering reactor heat; hose+pump for liquid circulation; heat utilizer; slippage seals+coupler #1 & #2 for adapting hose and hollow shaft of dyno-capacitor; terminal posts for high voltage DC output to supply commercial loads.

The heat utilizer can be used outside of the reactor housing unit, and drawing it inside just for convenience, and the preferred nuclear fuel is the enriched lutetium isotope 176Lu.

In contrast, sub-FIG. 13b is very simple. It only shows the zigzag pattern of the motion of neutrinos lens scan sub-system. The height of the pattern is marked as radius of dyno-capacitor, and the width is marked as thickness of the dyno-capacitor assembly.

Although there is better catalysis effect by focusing neutrinos to a point, however zigzag scan for diffusion is complicated and may be expensive.

By applying master and slave 2 lenses, it is also possible to get similar concentrated strength of neutrinos with single lens focal point system, as long as master lens can be large enough.

The main merit of 2 lenses system is that the slave lens can be adaptive by using mercury, so as to change its focal length or aperture dynamically, in turn, to conveniently regulate output for optimization of peak and valley time of hydro grid.

Also, the concentrated neutrino-rays form reasonable narrow parallel beam, and can evenly go through all disks without assistance of zigzag scan.

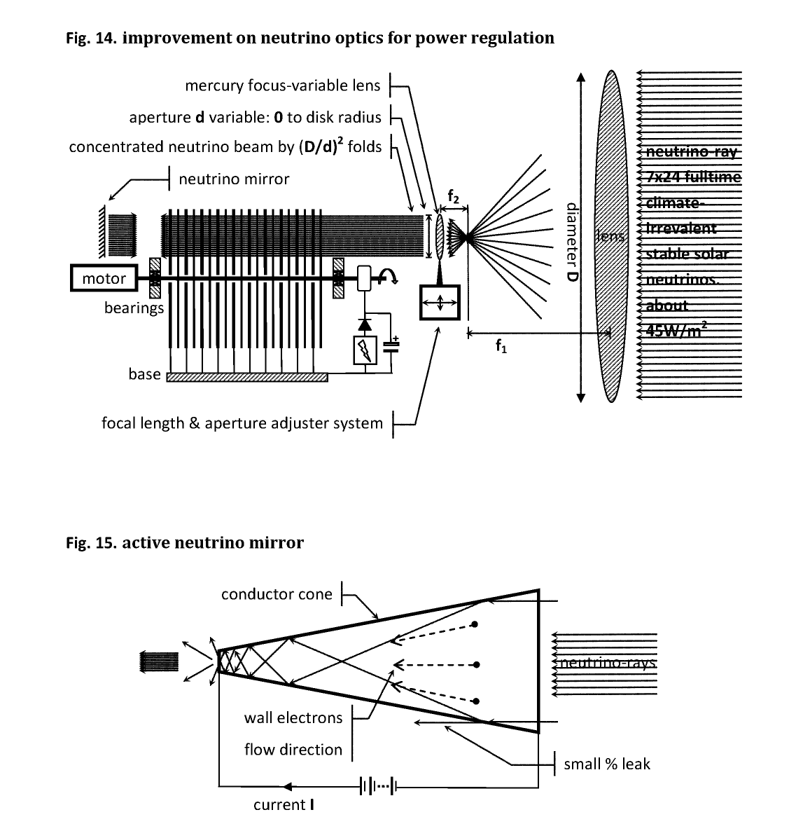

FIG. 14 just shows an improvement, where f₁ is the invariable focal length of master lens, f₂: the variable focal length of slave adaptive lens made of mercury and associated control sub-system, D: diameter of master lens, d: variable aperture and mirror shape just planar.

The magnification of neutrinos strength is (D/d)² that is not hard to be setup to 1 million above. As solar neutrino's energy flux on Earth is about 45 W/m², therefore the concentrated density can be amplified up to 45 megawatts per square meter.

If disk radius is far greater than width of the concentrated parallel neutrinos beam, only single dimensional scan is needed to diffuse neutrinos energy. Unlike the previous XY 2D zigzag mode, this 1D scan orientation is vertical to optical axis, i.e. just sideway motion.

As to the choice of moving module for the 1D scan, if master lens too huge, then drive the dyno-capacitor to scan, otherwise the optical system.

For easy to implement focus varying, mercury can be used for lens material, and isotope 201Hg enriched mercury is better though too expensive. The blackbox with inside cross arrows under the mercury lens stands for the focal length and aperture adjuster system.

Comparing with similar FIG. 13a, most peripheral parts are undrawn in FIG. 14 so as to emphasize the modified optical system.

The rich annotation in this figure can help quick understanding. The solar neutrinos flux of lens input is marked as 7×24 fulltime climate-irrevalent stable solar neutrinos rays with power density about 45 W/m². The big lens therein has a fixed focal length, and the small lens is the focal length variable mercury lens. The adjuster system for focal length and aperture is drawn as a functional blackbox underneath the small lens. The flat neutrinos mirror and the small lens bracket the half portion of the motor driven dyno-capacitor for improved catalysis effect.

### Alternative Method to Converge Low Energy Neutrinos

As large size neutrinos lens is very heavy, tracking the Sun may consume significant energy, hence alternative lightweight converger is desired.

FIG. 15 shows that a simple large cone comprising conductor sheet can converge low energy neutrinos, though inferior to convex lens in performance. Of course, those high energy neutrinos will not be affected, and just pass through wall or whatever matter, though undrawn.

A DC power supply is properly connected to both ends of the cone, i.e. large port to negative pole, and small port to positive pole. This setting make the electrons flow from large to small port along the wall of cone, so as to effectively whip neutrinos inward.

After neutrinos exit the small port, concentrated flux is gained, though no longer parallel rays like as entering rays at the large port, and small percentage wall leak is also inevitable.

This figure illustrates some exemplary paths of extreme low energy neutrinos entering the cone with current conduction along its wall. Many directions are symbolically showed: wall current, neutrino rays, exit scattering, leaked neutrinos, and the current leaving the power supply.

Researches show that the higher current, the better effect of convergence, but joule heat also increase, hence reasonable current is important.

I recommend forestalling it to feed the master lens in other compact system, so as to further enhance magnification.

Although the refractable extent of moderate to high energy neutrinos is far inferior to low energy neutrinos, special improvement is still available: by hooking metal lens to a DC electric current supply, but I prefer not to disclose the detail method because this energy band may be not adequate for subject inventions.

### Thermal Energy Utilization

As quite a proportion of produced energy is in heat, hence utilization of heat is worthy of serious consideration.

By using hollow shaft and heat exchanging fluid, most heat can be brought out from core of dyno-capacitor, but the plumbing couplers confront special engineering challenge, because the shaft itself is fast rotating, anyhow slippage seal couplers can fix it.

Other peripheral components of heat exchanging system include tank, working fluid, circulation pump, pipes, hoses, and heat utilizer or exchanger. Usually water is economical choice for work fluid, steam turbine is high grade heat utilizer, and in turn turbine can generate electricity too.

For moderate grade heat application, such as 100˜600° C., industrial heat exchanger is OK.

Therefore beta reactor can not only be configured as a high voltage electrical generator, but also as CHP (Combined Heat and Power) generator system.

### Afraid of Too Much Overhead Energy Consumption?

For purpose of energy production, the overhead internal energy consumption is desired as low as possible, so as to generate profit as high as possible efficiently.

As beta fuel max energy is capped by its nuclear properties, the only controllable consumption is the overhead energy, such as driving the shaft of dyno-capacitor, recharging battery of starter module, line loss, driving zigzag sub-system or 1D scanner, solar tracking, driving adaptive lens for adjustment of focal length and aperture, driving circulation pump for heat output, auxiliary signal sensing, processing and control system etc.

Most worried is probably the driving energy of shaft of dyno-capacitor.

To address this question, force analysis on disks should be done.

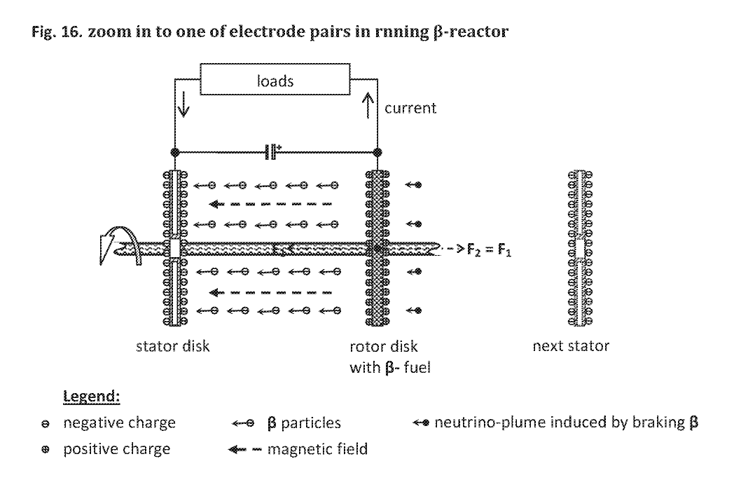

FIG. 16 illustrates the zoom-into local environment in magnified view, where the checkered disk is the rotor disk with beta minus fuel that is positively charged in stable running state, and its 2 neighboring disks are negatively charged, so it is attracted by left disk with electrostatic force F₁ as equally as attracted by right disk with |F₂|=|F₁| because identical distances to both sides.

As the 2 forces F₂ & F₁ are in opposite pointing, hence they cancel each other on the disk.

Another force is the recoil of beta particles leaving the fuel disk to left disk because of influence of alt-superconductor induced strong magnetic field, and this recoil force is only acting on left side, hence, the net balance is only this force, but luckily this recoil is too weak to be sensed by the disk, hence the total stress in axial direction can be ignored.

In radial direction, the centrifugal force is quite significant because of high speed spin, but this force does not constitute load of shaft.

In conclusion, the driving power on dyno-capacitor shaft is only used to overcome the bearing's friction and aerodynamic loss because of imperfect vacuum.

If the bearings are eliminated because of application of external independent permanent magnets levitation, then the driving energy can be further reduced greatly.

Thus it is possible to minimize the overhead energy consumption in favor of producing max net energy from speeded beta decay.

In fact, gamma photons may exist in this kind of betavoltaic reactor, but not drawn in FIG. 16.

This figure is also drawn with rich annotation for better serving peers, especially the legend lists 5 key graphic elements: positive charges, negative charges, magnetic field arrow, 3 particles, and the neutrino-flume induced by braking beta particles (external input neutrinos undrawn).

From this figure, it can be seen that the shaft and the 3 bombarded cathode disk with central shaft hole are both hollow, and the fluid working medium circulates inside the hollow cavity for heat transfer. The generated high DC voltage between spinning β-fuel disk and stator disk can be used to power commercial loads, and usually a capacitor is used to stabilize voltage.

As it is just a zoom-in view for one pair of disks, the view edge may contain a few of repeated parts of neighboring disk(s), so the fuzzy draw at the right side of this figure stands for next stator disk.

This not-for-scale figure provides a fancy zoom-in image of internal runtime scenario and other relevant readable information.

### Update to Statorless Dyno-Capacitor

By special mechanical design, it is possible to enable both anode and cathode to rotate in anti-parallel, i.e. mutual opposite, so as to double the induced magnetic field by alt-superconductor.

Because anode and cathode hold different polarity of charges, hence, if they rotate together in same direction, the total net magnetic field will be mutual cancelled to zero.

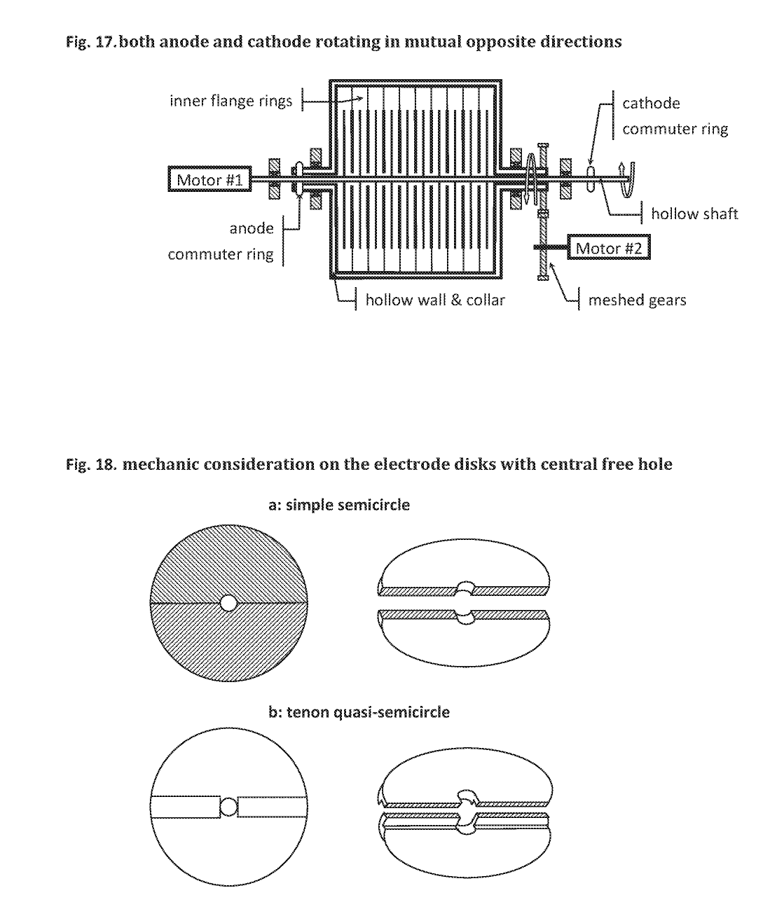

FIG. 17 illustrates such an improvement, where 2 motors #1 & #2 are deployed at both sides of dyno-capacitor, though even one motor can also work as long as a dedicated transmission mechanism is properly used.

The #1 motor serves anode shaft, while #2 serves cathode shaft that coaxially & narrowly hosts inside anode hollow shaft, and 2 pairs of bearings support respective shafts.

With such setting, the #2 motor cannot share common axis with #1, and that is why 2 meshed gears are used to couple with motor #2 for cathode drive.

All disks or semi-disks of cathode are fixed or casted with the inner flanges of cathode cylinder jacket which wall and collars are hollow for conducting heat exchanging fluid, and the collars also used as shaft.

In this figure, it can also be seen that the dyno-capacitor's shaft, outer wall and collars are all hollow, so as to allow the inside heat transfer fluid flow.

### Mechanic Consideration on the Electrode Disks

Accurate and quick fuel change, maintenance disassembly, system assembly and re-assembly all require special design for disks.

If all disks are single solid pieces, the difficulty of the above-listed jobs are incredibly hard.

There are 2 types of disks: type #1 is to be fixed with anode shaft, hence its diameter of central hole should match shaft in tight tolerance; type #2 is to be fixed with the inner rim of cathode cylinder, hence its diameter of central hole should be larger than type #1 so as to not block disk-shaft anode assembly.

No need of special design consideration for all types, but usually only type #2 should be considered for special design.

FIG. 18 illustrates how to embody the said type #2 disc electrode by combinating 2 pieces of semi-circle, where 2 choices are illustrated in 3D graphics, one is simple semicircle as illustrated in sub-FIG. 18a, another is the tenon quasi-semicircle as illustrated in sub-FIG. 18b.

Obviously it can facilitate the system assembly and fuel change.

If casting workmanship is used, cathode assembly comprises 2 semi-cylinders, which integrate semi-circle-disks as “tines” to inner rim with similarity on ensemble to an exotic “comb”.

As to the anode combo, there is no need to use 2 semi-circle pieces, and the disks & central pass-through shaft can be pre-assembled in tight tolerance or be casted in one integral piece.

Other 2 factors should also be considered: one is the heat expansion of materials, as it will slightly affect distance between disks; another is the mechanical strength to endure extreme high centrifugal stress.

### Double Fuel Setting

Although deploying single β− fuel on anode alone is workable, however if cathode can deploy β+ fuel simultaneously, i.e. double fuels, the reactor can be double powerful.

For best performance, decay energy Q(β+) should be commensurate with Q(β−), such as 20% or so differentiation, though there is no hope of finding 2 fuels with exact Q(β+)=Q(β−).

In fact, there are only a few of choices of high Q(β+) isotopes, such as potassium 40K with Q(β+)=1505 keV, lanthanum 138La with Q(β+)=1737 keV, vanadium 50V with Q(β+)=2206 keV, etc.

In all these choices, there is a common feature: very low sibling abundance, e.g. 40K only 0.01%, 138La 0.1%, 50V 0.25%, therefore the enrichment cost is considerably a pain if selected.

In opposite direction to β− projectiles, the positron β+ projectiles from beta plus fuel on the cathode will fly to anode, as well as recharge the “nuclear battery”.

As beta plus decay can be accelerated by electrons bombardment, as well as beta minus can be accelerated by positrons bombardment, hence such double fuels configuration will function more efficiently and more powerful, though the focused neutrinos catalyze beta minus decay better than beta plus decay.

Because electron and positron trend to annihilation into 2 photons of 511 keV while meeting between disk electrodes, hence there is extra heat produced in this case.

Some double beta plus 2β+ isotopes may be potential candidates. In this case the first stage β+ is preferred to undergo electron capture so as to utilize the remnant kinetic energy of arrived β− from anode for catalysis.

### About Nuclear Energy Level of the Beta Fuel

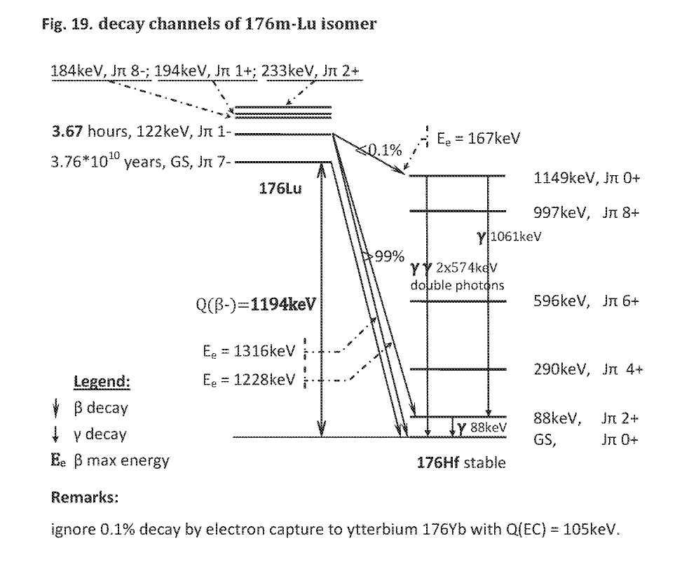

FIG. 19 illustrates the nuclear energy level of the proposed beta fuel lutetium 176Lu, especially isomer concept is emphasized.

In fact, the detail reason of such selection is well described in § 11 and § 12 of the first section.

In a summary: 176Lu has a wonderful low energy isomer state 122 keV with spin-parity Jπ=1− and half life merely 3.67 hours by beta decay to hafnium, plus its decay energy Q(β−)=1194 keV is more appreciable, because such energetic decay predicates energy density as high as 23 MW per kilogram, according to my formula.

Its sibling abundance of 176Lu is 2.6%, in just so-so degree, almost 4 times of 0.7% of the famous fission fuel 235U, and its family abundance in Earth is slightly less than uranium, hence these data is pretty good, especially regarding enrichment cost.

In fact, 176Lu has both β− and electron capture decay, but the latter energy Q(EC) 105 keV too small, thus branch ratio towards ytterbium 176Yb merely 0.1%, i.e. ignorable level.

The first energy level is just the aforementioned isomer state, and 2nd, 3rd, 4th levels closely jostle into narrow band with width of about 50 keV: respectively 184 keV, Jπ 8−; 194 keV, Jπ 1+; 233 keV, Jπ 2+.

Without catalysis of focused low energy neutrinos, natural 176Lu is just an isotope of expensive stable and harmless metal lutetium, because its half life is about 10 times of age of the Earth.

When focused neutrinos excite it from ground state to isomer state, the miracle happens: it sublimes to nuclear fuel!

The 99% decay channels are β− to ground state Jπ 0+ of hafnium 176Hf with β energy 1316 keV, and β− to 1^{st} level of 176Hf 88 keV Jπ 2+ with β energy 1228 keV, then 88 keV gamma decay to ground state of 176Hf, the ignorable or unnoticeable channel is β− to 5^{th} level of 176Hf 1149 keV Jπ 0+, then double 574 keV photons gamma decay to ground state, or cascading 1061 keV and 88 keV gamma chain.

The double photons decay is caused by the special transient 0+ to 0+, as only 2 anti-parallel photons emission can cancel spin each other to zero. Anyway it is in the unnoticeable channel.

There are three energy levels between the mentioned 1149 keV and 88 keV: 997 keV with Jπ 8+, 596 keV with Jπ 6+, and 290 keV with Jπ 4+. Anyway, these levels are not stayed by the isomer decay transition.

Although undrawn in FIG. 19, neutrino-catalysis can also excite lutetium 176Lu to higher level than the isomer state, then fall down to isomer (high chance) or GS (ground state) instantly.

### Invention #3: Heat Output Only Beta Reactor

The most pristine state of energy existence is heat, and its carrier is the massive medium where every single atom or molecule runs or scatters with equal or almost equal kinetic energy in random direction, and it is the Brownian motion (if fluid) or lattice phonon vibration (if solid or crystal) that make medium feel hot.

A commercial nuclear reactor's core comprises circulation water and heat source where water soaks 235U fissionable fuel and is heated by fission energy, and at end of heat sinker, heat energy is converted to electricity out of core in last stage.

Not like as previous invention where electricity is targeted from the core of beta reactor, hereby I present pure heat output beta reactor.

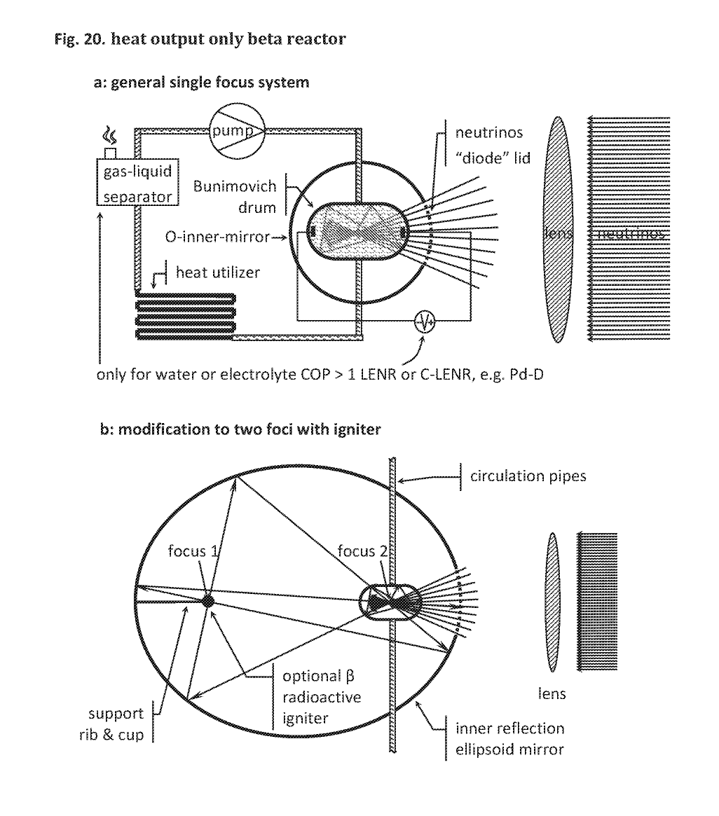

FIG. 20 shows a heater with fluid circulation, it is powered by a beta reactor, and the beta reactor is catalyzed by focused low energy neutrinos via proper lens. Tow sub-figures are used to illustrate the main assembly and possible alternative neutrino-lens.

As no electric current output is required from fuel itself, the random-oriented beta projectiles can be tolerated, hence alt-superconductor is eliminated, and anyway catalysis of focused neutrinos is still the key to tap out beta decay energy, despite no more catalysis of alternative superconductor induced super strong magnetic field.

From the main sub-FIG. 20a, it can be seen that this invention is obviously simplified, compared with the full fledged high voltage output beta reactor.

To maximize catalysis of the focused neutrinos, annotated as O-inner-mirror in figure, a spherical inner mirror is used with optional small diode-like lid that is preferred to allow extreme low energy neutrinos import but not export.

The focus of lens is just located at the center of sphere mirror, and the lid size and position is supposed to cover the midway of incoming converging neutrino-ray cone.

A “drum” is plumbed in fluid circulation loop, also totally enclosed by outer sphere mirror, and the cross section that goes through both centers of facial circles is mathematically Bunimovich stadium. As per the ergodicity of such geometry, entered low energy neutrinos are not easy to leave, hence more scatter chances between neutrinos and matter.

The optical axis lies on the cross section that is bordered by drum's max waistline circle and goes through its center that also coincides with sphere mirror center and lens focus.

The circulation pipes run through the sphere shape inner mirror via diametric 2 end locations, thereby 2 holes on mirror should be reserved in commensurate size with pipes.

A pump is used to drive working fluid in circulation, and its flow direction does not matter.

The gas-liquid separator is embedded in plumbing loop, so as to expel gas that is generated by nuclear reaction and/or chemical reaction. If the gas is flammable and abundant, it should be sent to collect tank in feeding of combustion utilization for further energy production.

Depending on fuel type, gas-liquid separator may be no necessary.

Heat utilizer is an important unit, and determined by end user's requirement: it can be a simple heat exchanger, or heat engine, e.g. steam turbine, for electricity generation.

The lifestyle of beta fuel can be quite flexible, exist either in solid or melted fluid or even a part of electrolyte, depending on embodied application.

For solid fuel, it is deployed at focal point of neutrinos lens, and immersed in circulating water.

Usually metallic fuel can be simultaneously used as electrode to electrolyze water into HHO, a highly combustible gas fuel, so as to harvest both nuclear energy and chemical energy. As long as the output heat energy is greater than input energy, i.e. COP >1, then it is worthwhile.

By analysis on ratio of estimated or generated nuclear energy to chemical energy, if the ratio is very high, then such combination is not necessary and the electrolysis co-application can be eliminated to reduce low value hustle and bustle, e.g. 176Lu isomer fuel is powerful enough in nuclear energy alone.

For low melt point beta fuel, e.g. 116Cd, just use it in melted state, and circulate it directly and insularly to exchange heat with ambient interfaces. The DC power supply & liquid-gas separator are unnecessary in this case.

For electrolytic fuel, the key isotope is ingredient atom of electrolyte molecule, and aqua-ionized after resolved in dissolvent, e.g. water.

In this case, the reactor can be configured as neutrino-catalyzed LENR e.g. Pd-D system or C-LENR system, e.g. VCl₃ electrolyte+titanium electrodes, where a DC power supply for LENR, or pulse high voltage DC power supply for C-LENR, in addition, a pair of electrodes are need.

The introduction on C-LENR (Collective Low Energy Nuclear Reactions) is presented in § 17 of the first section.

As a new variety, sphere mirror can be replaced by ellipsoid inner reflection mirror.

The sub-FIG. 20b just shows the modification, where there are no major changes, except the drum assembly is located at the second focus of ellipsoid and the first focus of ellipsoid is occupied by optional beta radioactive igniter, such as tritium ice, so as to provide primer neutrinos or antineutrinos. A support rib and cup may be needed for using the other focus.

With 2 foci in ellipsoid, this mirror replacement provides some flexibility, for example, deploying 2 parallel-linked drum assemblies at each focus to enhance digestion of focused neutrinos energy, or installing special sensor or igniter at the spare focus.

In sub-FIG. 20b, some peripheral parts undrawn, so as to emphasize new 2 foci optic option.

### Invention #4: Artificial Low Energy Neutrinos Source

Without high energy accelerator or strong radioactive element, neutrinos source can still be built in low cost means, though orthodox physics temporarily does not confirm my theory.

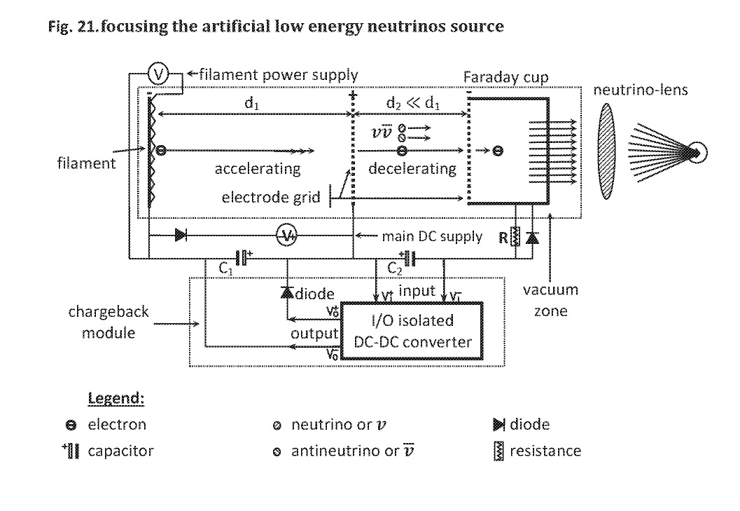

FIG. 21 presents such a neutrinos source system based on the theory that linear braking on electrons can not only recharge the power supply, but also generate pairs of neutrino and antineutrino provided some prerequisite conditions are met. The detail new physics is described in § 14 of the first section.

As annotated in the figure, thermal electrons are emitted from heated filament or grilled filaments matrix as cathode, and then electrons are accelerated in swarm towards the sieve-like anode by main DC power supply.

With high kinetic inertia, electrons continue to pass through the anode sieve, via very short distance, until suddenly stopped or scattered by the Faraday cup which is covered by another electro-sieve functioning as cathode. Such is called sudden braking stage.

In the initial or warm-up time, the Faraday cup will get temporary hot as the bombardment effect, because deceleration electric field that is powered by the capacitor C₂ can be only gradually established. Therefore, the ohms of resistance R should be reasonably tuned for current limitation and good efficiency.

The diode in parallel with the resistance R functions to only collect electrons from Faraday cup, i.e. let the decelerating transition only recharge the capacitor C₂, so as to make the sieve electrode on top of Faraday cup as a “float” negative pole with changing potential.

The initial bombardment provides big electric current to recharge the said capacitor, and soon its voltage is saturated, as well as stable braking electric field becomes ready, in turn, Faraday cup can collect gently moving electrons and no longer hot. Now equilibrium state is reached.

It is just in this short sudden braking stage that neutrino and antineutrino pairs radiate out, of course, this stage also continues to recharge the “volatile power supply”, i.e. capacitor C₂ with most braked energy.

To reclaim braked energy, a chargeback module is applied to transfer surplus electric energy stored in C₂ to capacitor C₁ that is also serving the first stage acceleration.

As the main DC supply and C₁ cooperate “shoulder to shoulder”, if voltage-of-C₁+0.7V (the saturated voltage of diode) is larger than main DC supply, then input power temporarily pauses serving acceleration stage, and C₁ takes over full duty at this moment, else they share the duty.

In principle, the chargeback module is mainly a DC to DC converter, marked by dotted box in the figure, and its in-out ports should be isolated by internal magnetic coils of transformer. Its core is labeled as “I/O isolated DC-DC converter” abstract function block. The core' attached diode makes sure the output terminal to only output for assisting acceleration.

The emitted neutrinos and antineutrinos can be treated as parallel rays, and a lens can be arranged to face the ray direction for focusing neutrinos.

The lens can be located at any convenient distance to the neutrinos source, because neutrinos have excellent penetration ability.

As neutrino and antineutrino behave differently on catalyzing beta decay, but they are mixed together in this source, hence separation does make sense because neutrinos v only good for β− as well as antineutrinos v̅ only good for β+, and currently there is no effective means to separate, though I am working hard to fix it.

Even vv̅ mixed, at focused point, there is still positive effect because concentrated neutral current energy can also excite nuclei to higher energy level, so as to trigger possible catalysis.

As only low energy neutrinos focusable, thus too high acceleration voltage is not necessary. For example, if 50 keV is the expected neutrino mean energy, then empirically, the voltage upper limit is about 500 kV.

Filaments can be wired in planar grill or matrix in any shape and area, anyhow, large area and dense arrangement can always exhibit better performance.

By adjusting the cathode filament electric current, its temperature will be changed, so as to affect the thermal electrons generating rate and density, anyway the polarity of filament voltage does not matter, even AC power supply works too. This auxiliary power supply is annotated as “filament power supply” in the figure.

As the acceleration pathway d₁ is reasonably long enough, according to my theory, such gradient of acceleration is not supposed to produce neutrinos, in contrast, the deceleration pathway d₂ should be short enough, so as to produce neutrino-antineutrino pairs effectively.

All electrodes, filament & Faraday cup should be enclosed in vacuum capsule as in conventional vacuum tube, because air molecules can disturb electron's speeding and braking, and this vacuum zone is indicated as a dotted-boundary box in the figure.

In the presented beta nuclear high voltage power generator, solar neutrinos can be replaced by herein system. Although this replacement can save the cost of sun-tracker, artificial neutrinos source is very low efficient, and its dose may not be strong enough.

Instead of intricate I/O isolated DC-DC converter, why not directly use the main DC supply for braking stage?

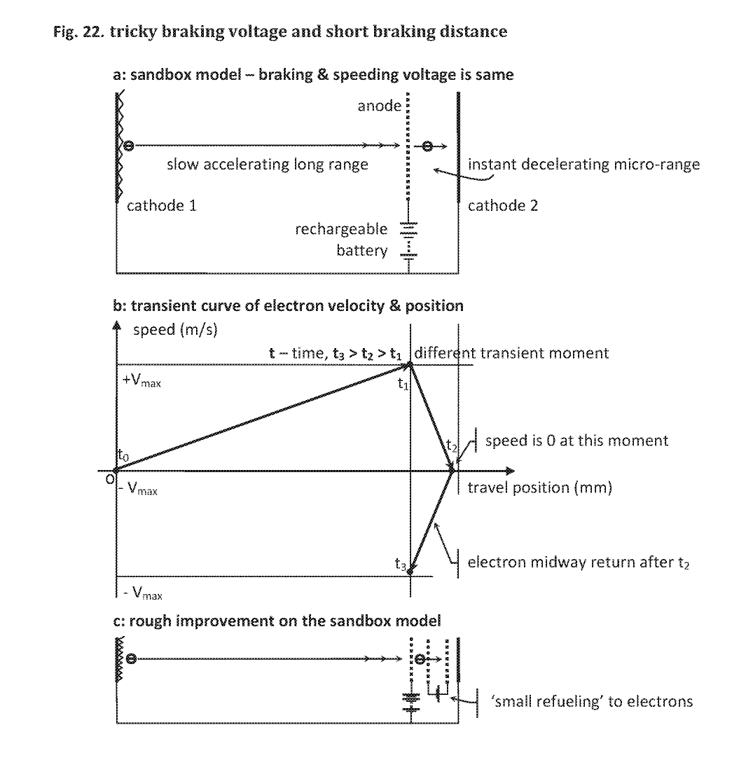

FIG. 22 illustrate the embarrass situation if deceleration voltage is equal to the acceleration voltage, and three sub-figures are employed for detail description.

Sub-FIG. 22a is the sandbox model that features equal voltage for both speeding and braking. One sieve-style anode and 2 cathodes are deployed at proper positions; the power supply is assumed of a bank of batteries; slow accelerating long range is marked about the left portion and instant decelerating micro-range is marked about the right portion.

Sub-FIG. 22b shows the transient curve of electron velocity and position as time goes by.

At t₀ moment, the electron starts to leave cathode, then it is linearly accelerated to max at t₁ moment and arrive anode, then penetrates anode and begins to be decelerated with linear reduction of velocity until standstill at t₂ moment while it is very close to the final cathode, but unfortunately no chance of landing on final cathode, because of minor energy loss in collision with anode & residual air and feedback to DC supply.

Of course, because velocity=0 state is unstable, therefore U-turn then re-acceleration will occur at t₂ moment until max velocity is regained at t₃ moment.

It will also render same situation if deceleration voltage is greater than the acceleration voltage.

Sub-FIG. 22c expresses a rough improvement on the sandbox where a “small refueling” low voltage mini acceleration stage is inserted midway, so as to make sure electrons can land on final cathode and be still warm but not hot. It may overcome the drawbacks, but more complicated improvement is still needed.

1. An alternative room temperature superconductor system comprising comb-like dense arrangement of parallel disks that is interlacedly grouped as cathode and anode and charged with voltage in same way of manipulation or treatment on a capacitor.

2. In addition to claim 1, one of the said 2 groups of disks can be coupled to shaft that is driven by a motor so as to create high virtual current.

3. In addition to claim 1, even all the 2 groups of disks can also be coupled to respective shafts that are driven by external mechanic power source(s), and the cathode group and anode group should rotate in opposite directions.

4. In addition to claim 1, the spacing interval of disks and area and in-between dielectric medium are reasonably determined by compliance with capacitor design practice.

5. In addition to claim 1, the shaft(s) can be either supported by bearings or levitation in strong field of permanent magnets, all in purpose of low friction.

6. A beta nuclear reactor with direct current output that is based on the optical system focused neutrinos catalysis and alt-superconductor system claimed in 1.

7. In addition to claim 6, beta fuel is carried on the designated disks hosted in so-called dyno-capacitor system as defined in description of patents, i.e. if the fuel has beta minus tendency, e.g. preferred lutetium 176Lu, then let disks in anode group carry it, else if it has beta plus tendency, then let disks in cathode group carry it.

8. In addition to claim 6, the lens that is made of heavy metal, such as lead or mercury, is deployed to focus neutrinos inside fuel and aim or track the neutrinos source, either the Sun or other source, and the lens geometry parameters are determined by formula of focal length, given refractive index of neutrinos on specific material.

9. In addition to claim 6, opt to deploy neutrinos mirror simultaneously in the said optical system, so as to maximally harvest neutrinos energy and spin angular quanta cracking effect on fuel.

10. In addition to claim 6, beta minus and beta plus fuel can be used simultaneously provided the former is carried by disks in anode group and the latter is carried by disks in cathode group, and any one group rotate or both groups rotate in opposite directions.

11. In addition to claim 6, a DC-DC step-up module is needed to facilitate rechargeable battery or batteries bank to start the reactor by providing initial reasonable bias voltages over electrodes.

12. In addition to claim 6, a mechanism is used to move lens by zigzag scan if neutrinos are converged to focus, or by the sideway scan if neutrinos are converged to a concentrated parallel beam, so as to evenly disperse focused neutrinos energy to everywhere in fuel.

13. In addition to claim 6, optionally a mechanism is used to change the lens focal length and aperture diameter so as to evenly disperse focused neutrinos energy to everywhere in fuel, if the optical system converges incident neutrinos rays into a concentrated narrow parallel rays, and liquid material is used for lens.

14. In addition to claim 6, the shaft(s) should be hollow and/or disks hollow if the design is permitted, so as to conduct heat exchanging fluid in circulation, and to facilitate output of thermal energy.

15. A variety of claim 6 that eliminates the dyno-capacitor system and features pure intrinsic thermal energy output that comprises a sphere or ellipsoid inner mirror and Bunimovich drum that is positioned around focus of lens and inlined in heat exchanging fluid circulation loop.

16. In addition to claim 15, the fuel can be solid or melted fluid or a constituting element of electrolyte, respectively the heat exchange working fluid varies from water, fuel itself, or aqueous solution.

17. In addition to claim 15, if fluidic work medium contains fuel, then an electrolysis system positioned around focus of neutrinos lens can be embedded to generate secondary gas fuel, such as HHO, so as to harvest chemical energy and nuclear energy simultaneously if they are in matchable ratings, so as to get higher overunity effect.

18. In addition to claim 15, optionally, if fluidic work medium contains fuel, then a DC high voltage supply that works in pulse mode and is positioned around focus of neutrinos lens, can be embedded to generate nuclear energy via C-LENR (Collective Low Energy Nuclear Reaction) as defined in description of subject application.

19. An artificial neutrinos source comprises anode, first cathode that is a hair of filament or planar matrix of filaments, final cathode, Faraday cup, I/O isolated DC to DC chargeback module and auxiliary parts e.g. acceleration-end capacitor, deceleration-end capacitor, peripheral resistances and diodes, and of the system, the filament(s) should be powered for establishing proper hot temperature so as to emit thermal electrons efficiently.

20. In addition to claim 19, the spacing interval of accelerating zone between first cathode and anode is reasonably determined so as to make the electric field strength not high enough to generate neutrino-antineutrino pairs and make DC power supply comfortable.

21.-24. (canceled)
